(19) United States
(12) Patent Application Publication
(10) Pub. No.: US 2013/0281155 A1
(43) Pub. Date: Oct. 24, 2013

(54) SYSTEM, ELECTRONIC DEVICE, AND CHARGER

(71) Applicant: KYOCERA Corporation, (US)

(72) Inventors: Takumi Ogata, Kanagawa (JP); Ryouji Kawashima, Kanagawa (JP); Takashi Ito, Kanagawa (JP)

(21) Appl. No.: 13/847,835

(22) Filed: Mar. 20, 2013

(30) Foreign Application Priority Data
Mar. 22, 2012 (JP) 2012-065307
Mar. 26, 2012 (JP) 2012-068871
Mar. 26, 2012 (JP) 2012-069636

(51) Int. Cl. H04B 1/38

(52) U.S. Cl. CPC H04B 1/3883
USPC 455/556.1; 455/573

(57) ABSTRACT

A system includes a charger and a smartphone. The charger includes a plurality of coils that transmit power through electromagnetic waves. The smartphone includes a power receiving unit, a communication unit, and a storage. The power receiving unit receives power transmitted from the coils. The communication unit communicates with a base station. The storage stores information of communication quality of the communication unit with the base station, when the power receiving unit is receiving power. The smartphone selects, from among the plurality of coils, a combination of the coils for transmitting power, based on information of the communication quality stored in the storage. The charger transmits power by the coils, based on the selection by the smartphone.

### CROSS-REFERENCE TO RELATED APPLICATIONS

This application is based on and claims the benefit of priority from Japanese Patent Application Nos. 2012-065307, 2012-068871 and 2012-069636, respectively filed on 22 Mar. 2012, 26 Mar. 2012 and 26 Mar. 2012, the contents of which are incorporated herein by reference.

### BACKGROUND

1. Field

The present invention relates to a system, an electronic device, and a charger.

2. Related Art

An electronic device including a touch-screen display is known technology. Examples of electronic devices include, for example, a smartphone and a tablet. The electronic device detects finger or stylus pen gestures via the touch-screen display. The electronic device is operated in accordance with the gestures thus detected.

Basic operations of an electronic device including a touch-screen display are implemented by an OS (Operating System) such as Android (registered trademark), BlackBerry (registered trademark) OS, Symbian (registered trademark) OS, iOS, Windows (registered trademark) Phone, etc. installed in the electronic device.

It may be noted that contactless charging without having an electric contact with a charger by utilizing electromagnetic induction has been proposed for such an electronic device. The charger includes a plurality of coils, and supplies power to the electronic device by applying an electric current to at least one of the coils to generate electromagnetic waves.

In a case in which a charging surface of the charger is sufficiently wide in comparison to the electronic device, the position of the electronic device on the charging surface varies each time it is used. Therefore, in order to enhance the charging efficiency of the electronic device, the charger needs to apply an electric current to the plurality of coils to generate electromagnetic waves from the entire charging surface. However, when the entire charging surface generates electromagnetic waves, the electric current is also applied to coils that are not involved with charging the electronic device, thereby resulting in loss. Electromagnetic waves also generate noise in wireless communication of the electronic device, and result in deterioration of the quality of wireless communication.

### SUMMARY

An object of the present invention is to provide a system, an electronic device, and a charger.

A system according to the present invention includes a charger and an electronic device. The charger includes a plurality of power transmitting units that transmit power through electromagnetic waves. The electronic device includes a power receiving unit, a communication unit, and a storage unit. The power receiving unit receives power transmitted from the power transmitting units. The communication unit communicates with a base station. The storage unit stores information of communication quality of the communication unit with the base station when the power receiving unit is receiving power. The electronic device selects, from among the plurality of power transmitting units, a combination of the power transmitting units for transmitting power, based on the information of the communication quality stored in the storage unit. The charger transmits power by the power transmitting units, based on the selection by the electronic device.

It is preferable for the electronic device to select a combination of the power transmitting units, with which the communication quality is of at least a predetermined standard.

In a case in which there are a plurality of combinations of the power transmitting units with which the communication quality is of at least a predetermined standard, it is preferable for the electronic device to select a combination with which the communication quality is the best.

In a case in which there is no combination of the power transmitting units, with which the communication quality is of at least the predetermined standard, it is preferable for the electronic device to select a combination with which the communication quality is the best, among the combinations with which the communication quality is below the predetermined standard.

It is preferable for the electronic device to include a notification unit for notifying that the communication quality is deteriorated, in a case in which there is no combination of the power transmitting units with which the communication quality is of at least the predetermined standard.

In a case in which there is no combination of the power transmitting units with which the communication quality is of at least the predetermined standard, it is preferable for the electronic device to instruct the charger to reduce the amount of transmitting power from the power transmitting units.

A system according to the present invention includes a charging unit and an electronic device. The charger includes a plurality of power transmitting units that transmit power through electromagnetic waves. The electronic device includes a power receiving unit, a communication unit, and a storage unit. The power receiving unit receives power transmitted from the power transmitting units. The communication unit communicates with a base station. The storage unit stores information of communication quality of the communication unit with the base station when the power receiving unit is receiving power. The electronic device selects, from among the plurality of power transmitting units, a combination of the power transmitting units for transmitting power, based on charging efficiency of power in the power receiving unit, and based on the information of the communication quality stored in the storage unit. The charger transmits power by the power transmitting units, based on the selection by the electronic device.

It is preferable for the electronic device to select a combination of the power transmitting units, with which the charging efficiency is at least a predetermined efficiency, and the communication quality is of at least a predetermined standard.

In a case in which there are a plurality of combinations of the power transmitting units, with which the charging efficiency is at least the predetermined efficiency, and the communication quality is of at least the predetermined standard, it is preferable for the electronic device to select a combination with which the communication quality is the best among the combinations.

In a case in which there are a plurality of combinations of the power transmitting units, with which the charging efficiency is at least the predetermined efficiency, and the communication quality is of at least the predetermined standard, it is preferable for the electronic device to select a combination with which the charging efficiency is the best among the combinations.

In a case in which there is no combination of the power transmitting units, with which the charging efficiency is at least the predetermined efficiency and the communication quality is of at least the predetermined standard, it is preferable for the electronic device to select a combination with which the communication quality is the best, among the combinations with which the communication quality is below the predetermined standard.

It is preferable for the electronic device to include a notification unit for notifying that the communication quality is deteriorated, in a case in which there is no combination of the power transmitting units, with which the charging efficiency is at least the predetermined efficiency and the communication quality is of at least the predetermined standard.

A system according to the present invention includes a charger and an electronic device. The charger includes a plurality of power transmitting units that transmit power through electromagnetic waves. The electronic device includes a power receiving unit, a communication unit, and a storage unit. The power receiving unit receives power transmitted from the power transmitting units. The communication unit communicates with a base station. The storage unit stores information of communication quality of the communication unit with the base station when the power receiving unit is receiving power. The electronic device transmits the information of the communication quality stored in the storage unit to the charger. The charger transmits power by the power transmitting units, based on the information from the electronic device.

A system according to the present invention includes a charger and an electronic device. The charger includes a plurality of power transmitting units that transmit power through electromagnetic waves. The power receiving unit receives power transmitted from the power transmitting units. The communication unit communicates with a base station. The storage unit stores information of communication quality of the communication unit with the base station when the power receiving unit is receiving power. The electronic device transmits power charging efficiency in the power receiving unit and information of the communication quality stored in the storage unit, to the charger. The charger transmits power by the power transmitting units, based on the information from the electronic device.

An electronic device according to the present invention includes a power receiving unit, a communication unit, a storage unit, a control unit, and a transmitting unit. The power receiving unit receives power transmitted through electromagnetic waves from a charger including a plurality of power transmitting units. The communication unit communicates with a base station. The storage unit stores information of communication quality of the communication unit with the base station when the power receiving unit is receiving power. The control unit selects, from among the plurality of power transmitting units, a combination of the power transmitting units for transmitting power, based on the information of the communication quality stored in the storage unit. The transmitting unit transmits the combination selected by the control unit to a charger.

An electronic device according to the present invention includes a power receiving unit, a communication unit, a storage unit, a control unit, and a transmitting unit. The power receiving unit receives power transmitted through electromagnetic waves from a charger including a plurality of power transmitting units. The communication unit communicates with a base station. The storage unit stores information of communication quality of the communication unit with the base station when the power receiving unit is receiving power. The control unit selects, from among the plurality of power transmitting units, a combination of the power transmitting units for transmitting power, based on charging efficiency of power in the power receiving unit, and based on the information of the communication quality stored in the storage unit. The transmitting unit transmits the combination selected by the control unit to a charger.

A system of the present invention includes an electronic device and a charger. The electronic device includes an antenna unit, a plurality of power receiving units, and a first control unit. The antenna unit transmits or receives first electromagnetic waves that are used for communication. The plurality of power receiving units receive power through second electromagnetic waves that are used for the charging. The first control unit controls a second power receiving unit to receive power through the second electromagnetic waves in a case in which the antenna unit transmits or receives the first electromagnetic waves, the second power receiving unit being different from the first power receiving unit that is closest to the antenna unit among the plurality of power receiving units. The charger includes a power transmitting unit and a second control unit. The power transmitting unit transmits power through the second electromagnetic waves to a part or all of the plurality of power receiving units. The second control unit controls the power transmitting unit to transmit power through the second electromagnetic waves to the second power receiving unit in a case in which the antenna unit transmits or receives the first electromagnetic waves.

The first control unit includes a communication priority mode in which the antenna unit transmits or receives data. In the communication priority mode, it is preferable for the first control unit to use the second power receiving unit to receive power through the second electromagnetic waves, instead of using the first power receiving unit.

In a case in which power is received through the second electromagnetic waves, and the received signal strength of the first electromagnetic waves received by the antenna unit is below a preset second threshold value, it is preferable for the first control unit to set the mode to the communication priority mode.

The first control unit includes a power receiving priority mode for prioritizing power receiving. In the power receiving priority mode, it is preferable for the first control unit to use at least two of the power receiving units to receive power.

The electronic device further includes a secondary battery that stores power received by at least one of the plurality of power receiving units. In a case in which the remaining battery level of the secondary battery is below a preset first threshold value, it is preferable for the first control unit to set the mode to the power receiving priority mode.

It is preferable for one of the plurality of power receiving units to be a contactless antenna unit utilized for contactless communication.

The electronic device includes a transmitting unit that transmits a control signal for controlling power to be transmitted through the second electromagnetic waves toward the second power receiving unit in the communication priority mode. It is preferable for the charger to further include a receiving unit that receives the control signal; and it is preferable for the second control unit to control the power transmitting unit, based on the control signal.

It is preferable for the power transmitting unit to receive the control signal.

It is preferable for the power transmitting unit to receive the control signal through third electromagnetic waves different in frequency from the second electromagnetic waves.

An electronic device of the present invention includes an antenna unit, a plurality of power receiving units, and a control unit. The antenna unit transmits or receives first electromagnetic waves that are used for communication. The plurality of power receiving units receive power through second electromagnetic waves that are used for the charging. The control unit controls a second power receiving unit to receive power through the second electromagnetic waves in a case in which the antenna unit transmits or receives the first electromagnetic waves, the second power receiving unit being different from the first power receiving unit that is closest to the antenna unit among the plurality of power receiving units.

A system according to the present invention includes a charger and an electronic device. The charger includes a predetermined surface having a first area. The charger transmits power through electromagnetic waves. The electronic device receives power from the charger. In a case in which the electronic device is disposed in the first area, an electronic device receives power with at least a predetermined efficiency. The electronic device includes an image capturing unit, a control unit, and a notification unit. The control unit calculates its relative position with respect to the first area, based on an image of the charger captured by the image capturing unit. The notification unit notifies information regarding the relative position calculated by the control unit.

The notification unit is a display unit. It is preferable for the control unit to cause the display unit to display a reference image that is based on a position where a power receiving unit for receiving power through electromagnetic waves from the charger is disposed, and a target image that is based on the relative position thus calculated.

It is preferable for the control unit to cause the display unit to display the target image that is identical in shape with the reference image.

The charger is marked with a mark indicating the position of a coil for transmitting electromagnetic waves. It is preferable for the control unit to calculate the relative position, based on the mark captured by the image capturing unit.

The charger is marked with a mark indicating the position of a coil for transmitting electromagnetic waves, and a single or plurality of circles at a certain interval around the mark. It is preferable for the control unit to calculate the relative position, based on the circle(s) captured by the image capturing unit.

The charger is marked with a position image indicating the position of a coil for transmitting electromagnetic waves. It is preferable for the control unit to calculate the relative position based on the position image captured by the image capturing unit.

In a case of detecting an operation of starting charging, it is preferable for the control unit to calculate the relative position based on the image of the charger captured by the image capturing unit, and to display the reference image and the target image on the display unit.

It is preferable for the control unit to terminate the displaying of the reference image and the target image on the display unit, in a case in which the electronic device is placed on the charger.

It is preferable for the control unit to terminate the displaying of the reference image and the target image on the display unit, in a case in which a charging unit charges a rechargeable battery with at least a predetermined power receiving efficiency.

It is preferable for the control unit to terminate the displaying of the reference image and the target image on the display unit, in a case in which the electronic device is proximate to the charger at a distance equal to or shorter than a predetermined distance.

It is preferable for the control unit to detect the predetermined distance by a contrast detection method or a phase difference detection method which is based on the image captured by the image capturing unit.

It is preferable for the control unit to cause the display unit to display the reference image and the target image again, after terminating the displaying of the reference image and the target image on the display unit, in a case in which the power receiving efficiency for a rechargeable battery charged by a charging unit is reduced to be no more than the power receiving efficiency.

The control unit acquires placement information of the charger, and in a case in which the electronic device is proximate to the charger at a distance equal to or shorter than a predetermined distance based on the placement information, the control unit causes the image capturing unit to capture an image of the charger. It is preferable for the control unit to calculate the relative position based on the image, and cause the display unit to display the reference image and the target image.

The charger includes a communication unit that outputs a signal. In a case in which the electronic device is proximate to the charger at a distance equal to or shorter than a predetermined distance as a result of detecting the signal that is output from the communication unit, the control unit causes the image capturing unit to capture an image of the charger. It is preferable for the control unit to calculate the relative position based on the image, and cause the display unit to display the reference image and the target image.

It is preferable for the control unit to cause the display unit to display a message for prompting a user to start charging, in a case in which the remaining level of a rechargeable battery is no more than a predetermined value, and the electronic device is proximate to the charger at a distance equal to or shorter than a predetermined distance.

An electronic device according to the present invention is an electronic device that receives power from a charger. The electronic device includes an image capturing unit, a control unit, and a notification unit. The control unit calculates its relative position with respect to the first area, based on an image of the charger captured by the image capturing unit. The notification unit notifies information regarding the relative position calculated by the control unit.

A charger according to the present invention includes a predetermined surface having a first area. The charger transmits power through electromagnetic waves to the electronic device with at least a predetermined efficiency, in a case in which an electronic device including an image capturing unit is placed in the first area. The charger is marked with a mark or a position image to be captured by the image capturing unit, for the electronic device to calculate relative positions of the first area and the electronic device.

According to the present invention, it is possible to provide a system, an electronic device, and a charger.

### BRIEF DESCRIPTION OF THE DRAWINGS

FIG. 1 is a perspective view showing an external appearance of a smartphone according to an embodiment;

FIG. 2 is a front view showing the external appearance of the smartphone according to the embodiment;

FIG. 3 is rear view showing the external appearance of the smartphone according to the embodiment;

FIG. 4 is a diagram showing an example of a home screen;

FIG. 5 is a block diagram showing functions of the smartphone according to the embodiment;

FIG. 6 is a diagram showing a state where the smartphone 1 is being charged, in a system according to the embodiment;

FIGS. 7A and 7B are diagrams illustrating combinations of some coils in a charger;

FIG. 8 is a flowchart showing flow of charging processing by the system according to the embodiment, in a reception sensitivity priority mode;

FIG. 9 is flowchart following FIG. 8;

FIG. 10 is a flowchart showing a flow of the charging processing by the system according to the embodiment, in a charging priority mode;

FIG. 11 is a perspective view showing an external appearance of a smartphone according to an embodiment;

FIG. 12 is a block diagram showing functions of the smartphone according to the embodiment;

FIG. 13 is a diagram for illustrating coils included in a first antenna unit and a power receiving unit;

FIG. 14 is a block diagram showing functions of the charger;

FIG. 15 is a flowchart for illustrating operations for charging a secondary battery of the smartphone;

FIG. 16 is a block diagram showing functions of the smartphone according to the embodiment;

FIG. 17 is a diagram showing a configuration of a guidance system;

FIG. 18 is a diagram for illustrating a flow of operations for displaying a reference image on a display;

FIG. 19 is a diagram illustrating a flow of calculating displacement between the position of the charger in an image, and a position where the power receiving unit is disposed;

FIG. 20 is a diagram illustrating a flow of operations for displaying a target image on the display;

FIG. 21 is a diagram illustrating a case in which the reference image overlaps with the target image;

FIGS. 22A and 22B are diagrams illustrating a mark indicating the position of a coil, the mark being marked on the charger;

FIG. 23 is a diagram illustrating an example in which the charger is marked with a mark indicating the position of a coil for transmitting electromagnetic waves, and a plurality of circles at a certain interval around the mark;

FIGS. 24A and 24B are diagrams illustrating an example in which a part of the circle is analyzed to calculate the position of the coil;

FIGS. 25A and 25B are diagrams illustrating an example in which the position of the coil is calculated based on an image marked on the charger;

FIGS. 26A-C are diagrams illustrating an example in which the position of the coil is calculated based on an image marked on the charger;

FIG. 27 is a flowchart illustrating a first method of guiding the smartphone to a position where the efficiency of receiving power from the charger is high;

FIG. 28 is a flowchart illustrating a second method of guiding the smartphone to a position where the efficiency of receiving power from the charger is high;

FIG. 29 is a flowchart illustrating a third method of guiding the smartphone to a position where the efficiency of receiving power from the charger is high; and

FIG. 30 is a diagram showing a configuration of the charger.

### DETAILED DESCRIPTION

Embodiments for carrying out the present invention are described in detail with reference to the drawings.

A smartphone is hereinafter described as an example of an electronic device that configures the system according to the embodiment.

### First Embodiment

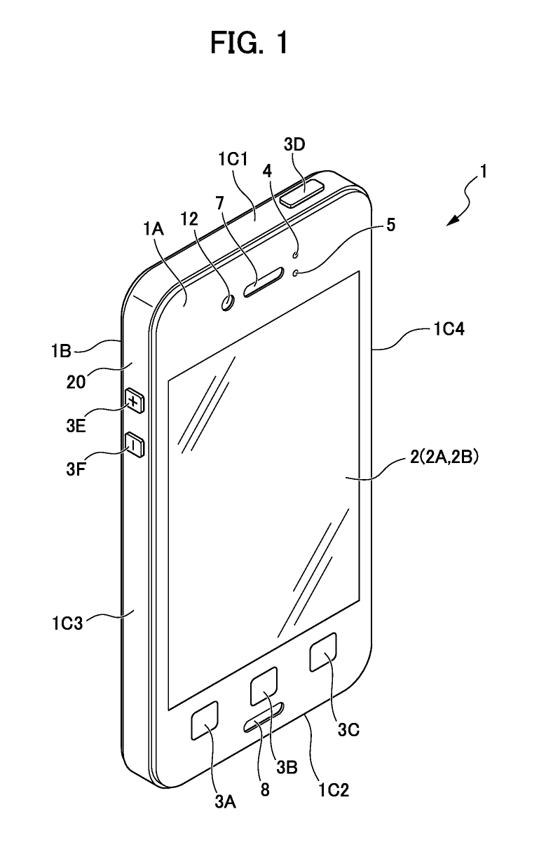

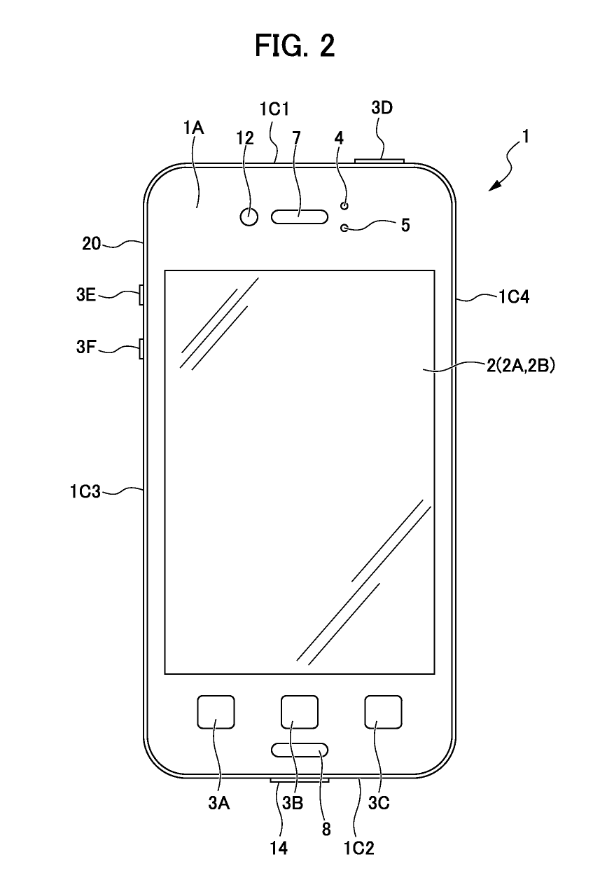

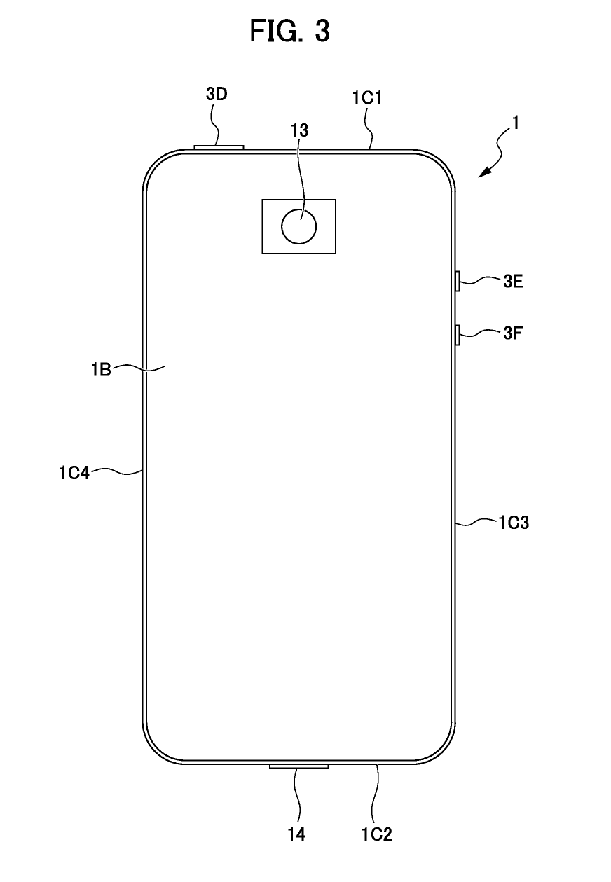

Descriptions are provided for an external appearance of a smartphone 1 that configures the system according to the embodiment with reference to FIGS. 1 to 3. As shown in FIGS. 1 to 3, the smartphone 1 has a housing 20. The housing 20 has a front face 1A, a back face 1B, and side faces 1C1 to 1C4. The front face 1A is a front face of the housing 20. The back face 1B is a back face of the housing 20. The side faces 1C1 to 1C4 are side faces that connect the front face 1A and the back face 1B. In the following descriptions, the side faces 1C1 to 1C4 may be collectively referred to as a side face 1C without specifying which face.

On the front face 1A, the smartphone 1 has a touch-screen display 2, buttons 3A to 3C, an illuminance sensor 4, a proximity sensor 5, a receiver 7, a microphone 8, and a camera 12. The smartphone 1 has a camera 13 in the back face 1B. The smartphone 1 has buttons 3D to 3F and an external interface 14 in the side face 1C. In the following descriptions, the buttons 3A to 3F may be collectively referred to as a button 3 without specifying which button.

The touch-screen display 2 has a display 2A and a touch screen 2B. The display 2A includes a display device such as a liquid crystal display, an organic electro-luminescence panel, or an inorganic electro-luminescence panel. The display 2A displays characters, images, symbols, graphics or the like.

The touch screen 2B detects a touch by a finger, a stylus pen or the like to the touch-screen display 2. The touch screen 2B detects a position where a plurality of fingers, the stylus pen or the like touch the touch-screen display 2.

A detection method for the touch screen 2B may be any method such as a capacitive sensing method, a resistor film method, a surface acoustic wave method (or an ultrasonic sensing method), an infrared ray method, or an electromagnetic induction method. In the following, for the purpose of simplifying descriptions, the fingers, the stylus pen or the like may be simply referred to as a “finger”, a touch by which to the touch-screen display 2 is detected by the touch screen 2B.

The smartphone 1 distinguishes type of gesture, based on a touch, a touch position, a touch period of time, or number of times touch occurs, as detected by the touch screen 2B. The gesture is an operation that is performed on the touch-screen display 2. Gestures that are distinguished by the smartphone 1 include a touch, a long touch, a release, a swipe, a tap, a double tap, a long tap, a drag, a flick, a pinch-in, a pinch-out, and the like.

The touch is a gesture where a finger touches the touch-screen display 2 (for example, a surface thereof). The smartphone 1 distinguishes the gesture of a finger touching the touch-screen display 2 as a touch. The long touch is a gesture of a finger touching the touch-screen display 2 for more than a certain period of time. The smartphone 1 distinguishes the gesture of a finger touching the touch-screen display 2 for more than a certain period of time as a long touch.

The release is a gesture of a finger being released from the touch-screen display 2. The smartphone 1 distinguishes the gesture of a finger being released from the touch-screen display 2 as a “release”. The swipe is a gesture of a finger moving while touching the touch-screen display 2. The smartphone 1 distinguishes the gesture of a finger moving while touching the touch-screen display 2 as a swipe.

The tap is a consecutive gesture of touch and release. The smartphone 1 distinguishes the consecutive gesture of touch and release as a tap. The double tap is a gesture of repeating a consecutive gesture of touch and release two times. The smartphone 1 distinguishes the gesture of repeating a consecutive gesture of touch and release two times as a double tap.

The long tap is a consecutive gesture of a long touch and release. The smartphone 1 distinguishes the consecutive gesture of a long touch and release as a long tap. The drag is a gesture of swiping from a starting point where a movable object is displayed. The smartphone 1 distinguishes the gesture of swiping from a starting point where a movable object is displayed as a drag.

The flick is a consecutive gesture of touch and release of a finger moving at a high-speed in one direction. The smartphone 1 distinguishes the gesture of touch and release of a finger moving at a high-speed in one direction as a flick. The flick includes: an upward flick of a finger moving in an upward direction on the screen; a downward flick of a finger moving in a downward direction on the screen; a rightward flick of a finger moving in a rightward direction on the screen; a leftward flick of a finger moving in a leftward direction on the screen; and the like.

The pinch-in is a gesture of a plurality of fingers swiping in mutually approaching directions. The smartphone 1 distinguishes the gesture of a plurality of fingers swiping in mutually approaching directions as a pinch-in. The pinch-out is a gesture of a plurality of fingers swiping in mutually receding directions. The smartphone 1 distinguishes the gesture of a plurality of fingers swiping in mutually receding directions as a pinch-out.

The smartphone 1 is operated in accordance with these gestures that are distinguished via the touch screen 2B. Therefore, intuitive and easy-to-use operability is achieved for a user. An operation, which is performed by the smartphone 1 in accordance with a gesture thus distinguished, is different depending on the screen that is displayed on the touch-screen display 2.

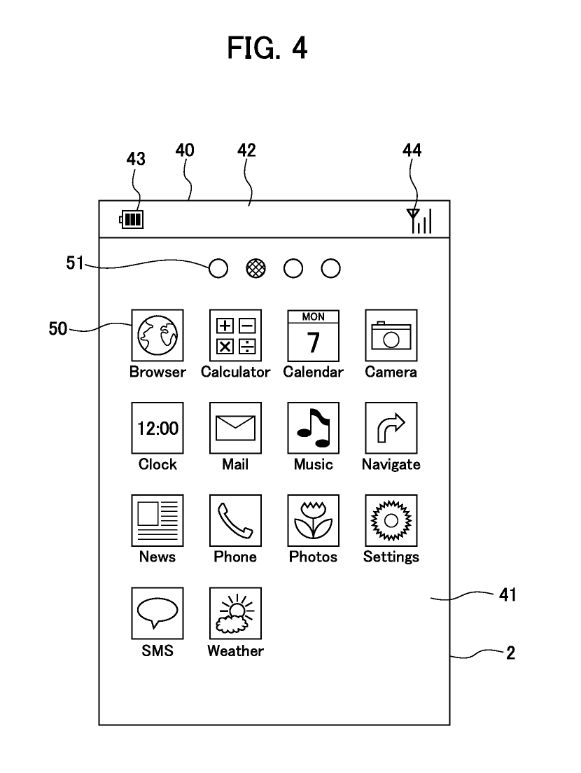

An example of a screen displayed on the display 2A is described with reference to FIG. 4. FIG. 4 shows an example of a home screen. The home screen may be called a desktop or an idle screen. The home screen is displayed on the display 2A. The home screen is a screen for allowing the user to select which application to be executed among applications installed in the smartphone 1. When an application is selected in the home screen, the smartphone 1 executes the application in the foreground. The screen of the application executed in the foreground is displayed on the display 2A.

The smartphone 1 can arrange icons in the home screen. A plurality of icons 50 are arranged in the home screen 40 shown in FIG. 4. The icons 50 are previously associated with the applications installed in the smartphone 1, respectively. When the smartphone 1 detects a gesture on an icon 50, an application associated with the icon 50 is executed. For example, when the smartphone 1 detects a tap on an icon 50 associated with a mail application, the mail application is executed. Here, for example, the smartphone 1 interprets the gesture on a position (area), which corresponds to a display position (area) of the icon 50 on the touch-screen display 2, as an instruction to execute an application associated with the icon 50.

The icon 50 includes an image and a character string. The icon 50 may include a symbol or graphics in place of the image. The icon 50 need not include any one of the image or the character string. The icons 50 are arranged in accordance with a predetermined rule. A wall paper 41 is displayed behind the icons 50. The wall paper may also be called a photo screen or a back screen. The smartphone 1 can use an arbitrary image as the wall paper 41. An arbitrary image is determined as the wall paper 41, for example, in accordance with the setting by the user.

The smartphone 1 can increase and decrease the number of home screens. The smartphone 1 determines the number of home screens, for example, in accordance with the setting by the user. Even in a case in which there are a plurality of home screens, the smartphone 1 selects a single home screen from the plurality of home screens, and displays the single home screen on the display 2A.

The smartphone 1 displays one or more locators on the home screen. The number of the locators coincides with the number of the home screens. The locator indicates the position of the currently displayed home screen. The locator corresponding to the currently displayed home screen is displayed in a manner different from the other locators.

Four locators 51 are displayed in the example shown in FIG. 4. This indicates that there are four home screens 40. In the example shown in FIG. 4, the second symbol (locator) from the left is displayed in a manner different from the other symbols (locators). This indicates that the second home screen from the left is currently displayed.

When the smartphone 1 detects a particular gesture while displaying the home screen, the home screen displayed on the display 2A is switched. For example, when the smartphone 1 detects a rightward flick, the home screen displayed on the display 2A is switched over to a next home screen to the left. When the smartphone 1 detects a leftward flick, the home screen displayed on the display 2A is switched over to a next home screen to the right.

An area 42 is provided at the top edge of the display 2A. A remaining-level mark 43 indicating a remaining level of the rechargeable battery, and a radio wave level mark 44 indicating field intensity of radio waves for communication are displayed in the area 42. In the area 42, the smartphone 1 may display current time, weather information, active applications, type of communication system, telephone status, a device mode, events that occurred in the device, etc. In this way, the area 42 is used for making various notifications to the user. The area 42 may be provided as another screen separate from the home screen 40. The position of providing the area 42 is not limited to the top edge of the display 2A.

The home screen 40 shown in FIG. 4 is an example, and shapes of various elements, layouts of various elements, the number of home screens 40, and the manner of various operations on the home screen 40 need not be as described in the above descriptions.

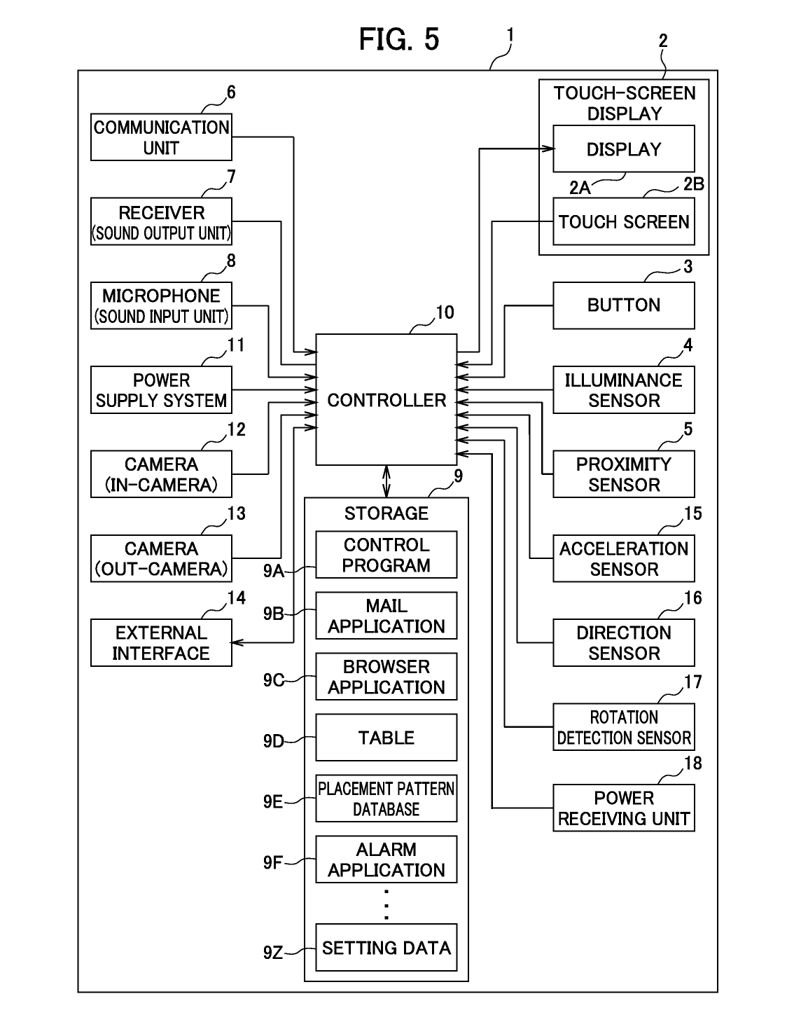

FIG. 5 is a block diagram showing a configuration of the smartphone 1. The smartphone 1 has the touch-screen display 2 as a display unit, the button 3, the illuminance sensor 4, the proximity sensor 5, a communication unit 6 as a wireless communication unit, the receiver 7 as a notification unit, the microphone 8, a storage 9, a controller 10 as a control unit, cameras 12 and 13, an external interface 14, an acceleration sensor 15, a direction sensor 16, a rotation detection sensor 17, and a power receiving unit 18.

As described above, the touch-screen display 2 has the display 2A and the touch screen 2B. The display 2A displays characters, images, symbols, graphics or the like. The touch screen 2B detects a gesture.

The button 3 is operated by the user. The button 3 has the buttons 3A to 3F. The controller 10 collaborates with the button 3 to detect an operation of the button. The operation of the button is, for example, a click, a double click, a push, and a multi-push.

For example, the buttons 3A to 3C are a home button, a back button or a menu button. For example, the button 3D is a power on/off button of the smartphone 1. The button 3D may also serve as a sleep/wake-up button. For example, the buttons 3E and 3F are volume buttons.

The illuminance sensor 4 detects illuminance. For example, the illuminance is intensity, brightness, brilliance, etc. of light. For example, the illuminance sensor 4 is used for adjusting the brilliance of the display 2A.

The proximity sensor 5 detects presence of a proximate object in a contactless manner. The proximity sensor 5 detects, for example, a face being brought close to the touch-screen display 2.

The communication unit 6 performs wireless communication. Communication methods implemented by the communication unit 6 are wireless communication standards. For example, the wireless communication standards include cellular phone communication standards such as 2G, 3G and 4G. For example, the cellular phone communication standards include LTE (Long Term Evolution), W-CDMA, CDMA2000, PDC, GSM, PHS (Personal Handy-phone System), etc. For example, the wireless communication standards include WiMAX (Worldwide Interoperability for Microwave Access), IEEE 802.11, Bluetooth (registered trademark), IrDA, NFC (Near Field Communication), etc. Communication unit 6 may support one or more of the communication standards described above.

When a sound signal is transmitted from the controller 10, the receiver 7 outputs the sound signal as sound. The microphone 8 converts sound such as the user's voice into a sound signal, and transmits the sound signal to the controller 10. The smartphone 1 may further have a speaker(s) in addition to the receiver 7. The smartphone 1 may further have a speaker(s) in place of the receiver 7.

The storage 9 stores programs and data. The storage 9 is also utilized as a working area for temporarily storing processing results of the controller 10. The storage 9 may include an arbitrary storage device such as a semi-conductor storage device or a magnetic storage device. The storage 9 may include several types of storage devices. The storage 9 may include a combination of a portable storage medium such as a memory card with a reader for the storage medium.

The programs stored in the storage 9 include: applications that are executed in the foreground or the background; and a control program that assists operations of the applications. For example, an application causes the display 2A to display a predetermined screen, and causes the controller 10 to execute processing in accordance with a gesture detected by the touch screen 2B. The control program is, for example, an OS. The applications and the control program may be installed in the storage 9 via wireless communication by the communication unit 6 or via a storage medium.

The storage 9 stores, for example, a control program 9A, a mail application 9B, a browser application 9C, and setting data 9Z. The mail application 9B provides electric mail functions of creating, transmitting, receiving and displaying electric mail. The browser application 9C provides a web browsing function of displaying web pages. A table 9D stores various tables such as a key assignment table. An arrangement pattern database 9E stores patterns of arrangement such as arrangement of icons displayed on the display 2A. The setting data 9Z provides various set-up functions regarding operations of the smartphone 1.

The control program 9A provides functions regarding a variety of control for operating the smartphone 1. For example, the control program 9A implements a telephone call function by controlling the communication unit 6, the receiver 7, the microphone 8, etc. The functions provided by the control program 9A include functions of executing a variety of control such as changing the information displayed on the display 2A in accordance with a gesture detected via the touch screen 2B. The functions provided by the control program 9A may be utilized in combination with functions provided by other programs such as the mail application 9B.

The controller 10 is, for example, a CPU (Central Processing Unit). The controller 10 may be an integrated circuit such as a SoC (System-on-a-chip) that integrates other constituent elements such as the communication unit 6. The controller 10 comprehensively controls the operations of the smartphone 1 to implement various functions.

More specifically, the controller 10 implements various functions by referring to data stored in the storage 9 as necessary, executing instructions included in a program stored in the storage 9, and controlling the display 2A, the communication unit 6, etc. The controller 10 may change the control in accordance with a result of detection by various detecting units such as the touch screen 2B, the button 3 and the acceleration sensor 15.

For example, the controller 10 executes the control program 9A to execute a variety of control such as changing the information displayed on the display 2A in accordance with a gesture detected via the touch screen 2B.

The camera 12 is an in-camera that photographs an object facing the front face 1A. The camera 13 is an out-camera that photographs an object facing the back face 1B.

The external interface 14 is a terminal to which another device is connected. The external interface 14 may be a universal terminal such as USB (Universal Serial Bus), HDMI (High-Definition Multimedia Interface), Light Peak (Thunderbolt), and an earpiece-microphone connector. The external interface 14 may be a terminal designed for exclusive use, such as a Dock connector. A device that is connected to the external interface 14 includes, for example, external storage, a speaker, or a communication device.

The acceleration sensor 15 detects a direction and level of acceleration that acts on the smartphone 1. The direction sensor 16 detects geomagnetic orientation. The rotation detection sensor 17 detects rotation of the smartphone 1. Results of such detection by the acceleration sensor 15, the direction sensor 16 and the rotation detection sensor 17 are utilized in combination to detect change in the position and posture of the smartphone 1.

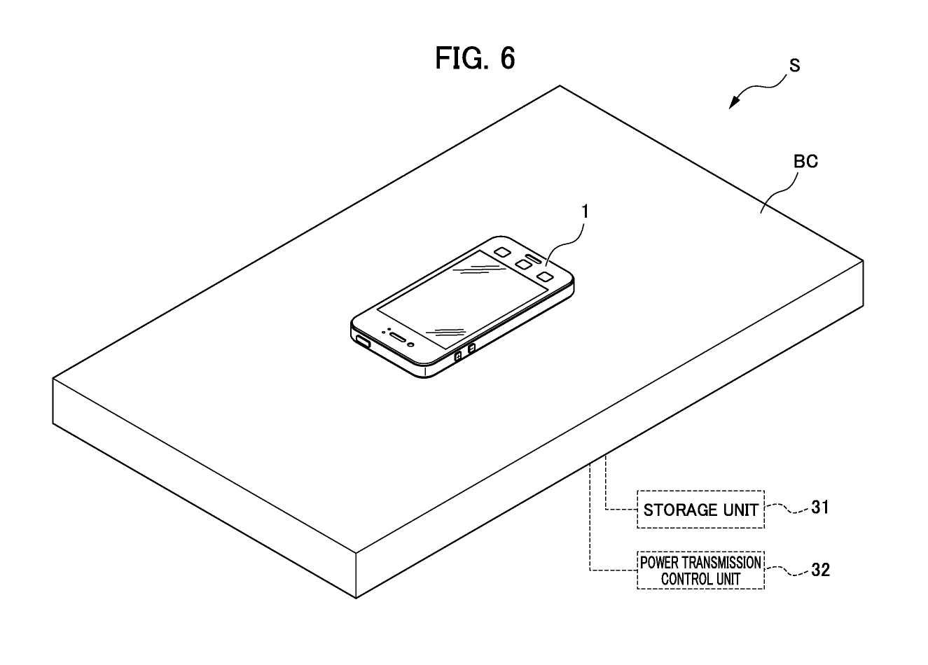

FIG. 6 is a diagram showing a state where the smartphone 1 is being charged, in a system S according to the embodiment. As shown in FIG. 6, when the smartphone 1 is placed on a charging surface of a charger BC, the smartphone 1 is charged by the power receiving unit 18.

The power receiving unit 18 does not have any electric contact with the charging surface of the charger BC including one or a plurality of coils C, but receives electromagnetic waves at a predetermined frequency (for example, 100 kHz) from the charger BC that configures the system S according to the present embodiment. The charger BC supplies electromagnetic waves to the power receiving unit 18 by utilizing electromagnetic induction. When electromagnetic waves are supplied, the power receiving unit 18 converts the electromagnetic waves into power and charges a battery (not shown) with the power.

The charger BC includes coils C as transmitting units, a storage unit 31, and a power transmission control unit 32.

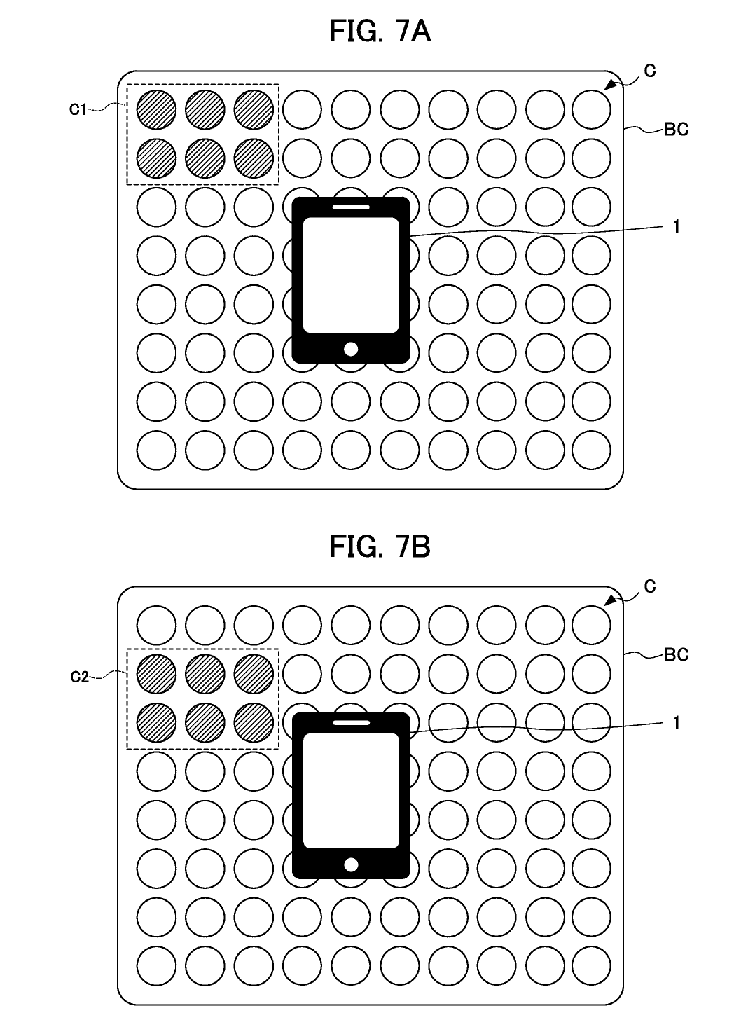

As shown in FIG. 7, the plurality of coils C are provided to the charger BC. In the present embodiment, each of the coils C is a circular coil with a size of, for example, 2 to 3 cm. The coils C generate electromagnetic waves by an electric current applied by the power transmission control unit 32. As a result, the coils C supply electromagnetic waves and transmit power to the smartphone 1 that is proximate to the coils C. The size and shape of the coils C are not limited to the size and shape described above.

Each of the plurality of coils C is associated a coil ID for identifying each coil. The coil ID is, for example, a combination of alphanumeric characters and symbols.

The storage unit 31 stores a combination of the coils C in a case of transmitting power by some of the coils C among the plurality of coils C. The storage unit 31 stores a combination of a plurality of patterns.

The power transmission control unit 32 generates electromagnetic waves by applying an electric current to the coils C, and supplies power to the smartphone 1 through the electromagnetic waves. Details of the power transmission control unit 32 are described later.

The system S including the smartphone 1 and the charger BC with such a configuration can efficiently charge the smartphone 1, while maintaining the quality of wireless communication, by controlling the charging. Descriptions are hereinafter provided for a specific configuration.

FIGS. 7A and 7B are diagrams illustrating combinations of some of the coils C in the charger BC.

FIG. 7A shows a combination C1 of six coils. Similarly, FIG. 7B shows a combination C2 of six coils. Each of these combinations shows one of the combinations stored in the storage unit 31. These combinations may be stored in the storage 9 of the smartphone 1. As shown in FIG. 7, in the present embodiment, a single combination is composed of a plurality of adjacent coils. For each combination of adjacent six coils, the storage unit 31 stores a combination ID for identifying the combination, and coil IDs corresponding to the combination, in association with each other. The combination ID is, for example, a combination of alphanumeric characters and symbols.

The combination of the coils is not limited to the aforementioned aspect, in which six coils are selected from a plurality of coils. For example, as an aspect, at least two coils or a single coil may be selected from a plurality of coils.

The smartphone 1 has a charge priority mode and a reception sensitivity priority mode. It is possible to switch the modes between the charge priority mode and the reception sensitivity priority mode, for example, by switching the home screen of the smartphone 1 to a mode setting screen on the touch-screen display 2, and accepting an operation from the user.

First of all, descriptions are provided for processing of the reception sensitivity priority mode.

When the charging is started, the charger BC and the smartphone 1 execute charge test processing for selecting an optimum combination from among the combinations of the coils.

When the smartphone 1 is placed on the charger BC, the power transmission control unit 32 transmits, to the smartphone 1, a start signal indicating that the charge test processing is stared. Regarding each of the plurality of combinations stored in the storage unit 31, the power transmission control unit 32 transmits power by applying an electric current to some of the coils C, based on the coil IDs associated with each of the combinations. When an electric current is applied to some of the coils C corresponding to a combination, the power transmission control unit 32 transmits a combination ID associated with the combination to the smartphone 1. When the power transmission by the coils C is completed for all the combinations, the power transmission control unit 32 transmits a termination signal indicating that the charge test processing is terminated, to the smartphone 1.

The combination ID is transmitted by the coils C and the coils configuring the power receiving unit 18. In this case, the combination ID is transmitted from the coils C, and received by the coils configuring the power receiving unit 18, for example, through amplitude shift keying communication at a frequency of 1 MHz.

In addition to the combination ID, the coils C also transmit information of the value of power that is output as electromagnetic waves by the coils C, to the power receiving unit 18.

The controller 10 receives the combination ID and the information of the value of power from the charger BC through the power receiving unit 18. In a case in which some of the coils C transmit power based on a combination corresponding to the combination ID, the controller 10 measures the quality of wireless communication of the communication unit 6, and the charging efficiency in the smartphone 1. The controller 10 causes the storage 9 to temporarily store the measurement result and the combination ID in association with each other. By measuring the environment of receiving radio waves (Ec/Io or RSSI (Received Signal Strength Indicator: RSSI)), the controller 10 measures the quality of wireless communication, and determines whether the quality of wireless communication satisfies a predetermined standard, based on whether the value of Ec/Io or RSSI is at least a predetermined value.

When the controller 10 receives a termination signal from the charger BC, the controller 10 refers to the measurement result temporarily stored in the storage 9, and identifies a combination with which the quality of wireless communication satisfies the predetermined standard and the charging efficiency is the highest. This combination is hereinafter referred to as the best combination. The controller 10 transmits the combination ID corresponding to the best combination, as instruction information, to the charger BC through the coils configuring the power receiving unit 18.

In the present invention, the charging efficiency is calculated by an equation: [value of power received by or charged to the smartphone 1]÷[value of power transmitted from the charger BC].

The “value of power received by the smartphone 1” may be, for example: the value of power received by the power receiving unit 18; the value of power measured at battery terminals of the smartphone 1 when the power receiving unit 18 receives power; the value of power that takes account of power loss in the power receiving unit 18; or the like.

The “value of power transmitted from the charger BC” may be, for example; the value of power of electromagnetic waves emitted from the coils C; the value of power transmitted by the charger BC as requested by the smartphone 1; or the like.

In other words, the charging efficiency is calculated based on the equation described above, by selecting a single value from among “values of power actually received by the smartphone 1”, and a single value from among “values of power transmitted from the charger BC”.

The charging efficiency is calculated based on the value of power; however, the present invention is not limited thereto, and the charging efficiency may be calculated based on, for example, voltage value or current value.

The power transmission control unit 32 receives a combination ID corresponding to the best combination, from the smartphone 1. The power transmission control unit 32 executes control to apply an electric current to the coils C corresponding to the coil IDs associated with the combination ID, and causes the coils C to transmit power.

Therefore, the system S transmits power by using the coils C corresponding to the combination, with which the quality of wireless communication satisfies a predetermined standard, and the charging efficiency is the highest. As a result, the charger BC can transmit power without applying an electric current to the coils C deemed unnecessary for charging the smartphone 1. This reduces the electromagnetic waves generated by the coils C deemed unnecessary for the charging; therefore, generation of noise in wireless communication is reduced. Thus, the system S can efficiently charge the smartphone 1, while maintaining the quality of wireless communication.

The coils C transmit a combination ID to the coils that configure the power receiving unit 18; however, the present invention is not limited thereto. In other words, a short distance wireless communication unit such as, for example, Bluetooth (registered trademark) is provided in advance to each of the charger BC and the smartphone 1. The charger BC and the smartphone 1 may communicate with each other by using the short distance wireless communication unit.

By measuring the Ec/Io or RSSI, the controller 10 measures the quality of wireless communication, and determines whether the quality of wireless communication satisfies a predetermined standard, based on whether the Ec/Io or RSSI value is at least a predetermined value; however, the present invention is not limited thereto. The controller 10 may measure the quality of wireless communication by measuring frame error rate (FER: Frame Error Rate) and bit error rate (BER: Bit Error Rate) by communicating with the base station through the communication unit 6.

The configuration and operations of the smartphone 1 have been described above; however, the present invention is not limited thereto, and may be configured by including respective constituent elements, with a method or program for improving the operability. In the above descriptions, a combination achieving the highest charging efficiency is identified; however, for example, a combination achieving at least a predetermined charging efficiency may be identified.

After receiving a termination signal, the controller 10 refers to a measurement result temporarily stored in the storage 9, and in a case in which the quality of wireless communication of the communication unit 6 does not satisfy the predetermined standard in all the combinations, the controller 10 identifies a combination with which the charging efficiency is the highest. The controller 10 transmits predetermined information indicating the identified combination to the charger BC. The predetermined information includes the combination ID indicating the identified combination, and information indicating that the quality of wireless communication does not satisfy the predetermined standard.

In a case in which the quality of wireless communication of the communication unit 6 does not satisfy the predetermined standard in all the combinations, the controller 10 may identify a combination with which the quality of communication is the best, among combinations with which the charging efficiency is higher than a predetermined threshold value, instead of identifying a combination with which the charging efficiency is the highest.

When the power transmission control unit 32 receives the predetermined information from the smartphone 1, the power transmission control unit 32 executes control to apply an electric current to the plurality of coils C corresponding to the coil IDs associated with the combination ID included in the predetermined information, and applies an electric current to the coils C to generate electromagnetic waves. The power transmission control unit 32 reduces the supply of electromagnetic waves in the plurality of coils C by reducing a predetermined amount of the electric current to be applied to the coils C.

Therefore, in a case in which the quality of wireless communication does not satisfy a predetermined standard at the time of charging, the system S reduces the supply of electromagnetic waves in the coils C corresponding to the combination with which the charging efficiency for the smartphone 1 is the highest. As a result, by reducing the intensity of electromagnetic waves that cause noise, the system S can further improve the quality of wireless communication of the smartphone 1.

In a case in which the power transmission control unit 32 reduces the supply of electromagnetic waves in the plurality of coils C, the power transmission control unit 32 transmits notification information indicating that the supply of electromagnetic waves is reduced, to the smartphone 1.

When the controller 10 receives the notification information from the charger BC, the controller 10 measures the quality of wireless communication of the communication unit 6. In a case in which the measured quality does not satisfy a predetermined standard, the controller 10 transmits predetermined information to the charger BC.

Subsequently, when the power transmission control unit 32 receives the predetermined information, the power transmission control unit 32 measures a current value applied to the plurality of coils C generating electromagnetic waves based on the combination, and identifies a power transmission amount. In a case in which the identified power transmission amount is at least a predetermined value, the power transmission control unit 32 further reduces the supply of electromagnetic waves in the plurality of coils C. The predetermined value refers to a minimum value of the current applied to the coils C when the smartphone 1 can be charged.

In other words, in the smartphone 1, in a case in which the quality of wireless communication of the communication unit 6 does not satisfy a predetermined standard, the power transmission control unit 32 gradually reduces the current value applied to the plurality of coils C within a range of enabling the charging. In a case in which the quality of wireless communication satisfies the predetermined standard, the power transmission control unit 32 maintains a state where the current value is reduced.

Therefore, the power transmission control unit 32 transmits the notification information to the smartphone 1, thereby making it possible to notify the smartphone 1 of the fact that the supply of electromagnetic waves is reduced. Since the power transmission control unit 32 repeats the reduction of the current value applied to the plurality of coils C within a range enabling the charging, the power transmission control unit 32 can reduce the electromagnetic waves that cause noise, and can improve the quality of wireless communication.

In a case in which the power transmission amount in the plurality of coils C is below a predetermined value after reducing the supply of electromagnetic waves in response to receiving the predetermined information from the smartphone 1, the power transmission control unit 32 transmits warning information indicating that the quality of wireless communication of the communication unit 6 is deteriorated, to the smartphone 1.

When the controller 10 receives the warning information from the charger BC, the controller 10 causes the touch-screen display 2 to display the warning information.

Therefore, the power transmission control unit 32 can make the user recognize that the quality of wireless communication of the smartphone 1 is deteriorated.

The controller 10 causes the touch-screen display 2 to display the warning information; however, the present invention is not limited to thereto. The controller 10 may use the receiver 7 to acoustically notify the user of the information indicating that the quality of wireless communication is deteriorated.

Next, descriptions are provided for processing of a charge priority mode.

Similarly to the reception sensitivity priority mode, when the smartphone 1 is placed on the charger BC, the power transmission control unit 32 transmits a start signal indicating that the charging is stared, to the smartphone 1. Regarding each of the plurality of combinations stored in the storage unit 31, the power transmission control unit 32 applies an electric current to some of the coils C to transmit power, based on the coil IDs associated with the combinations. When an electric current is applied to some of the coils C corresponding to a combination, the power transmission control unit 32 transmits a combination ID associated with the combination, to the smartphone 1. When the power transmission by the coils C is completed for all the combinations, the power transmission control unit 32 transmits a termination signal to the smartphone 1.

The controller 10 receives a combination ID from the charger BC. Similarly to the reception sensitivity priority mode, the controller 10 measures the quality of wireless communication of the communication unit 6, and the charging efficiency in the smartphone 1. The controller 10 causes the storage 9 to temporarily store the measurement result and the combination ID in association with each other.

A method of measuring the charging efficiency in the smartphone 1 is similar to the method of measuring the charging efficiency described above.

When the controller 10 receives the termination signal from the charger BC, the controller 10 refers to the measurement result temporarily stored in the storage 9, and identifies a combination with which the charging efficiency is the highest. This combination is referred to as the best combination. The controller 10 transmits the combination ID corresponding to the best combination to the charger BC, thereby providing notification of the best combination.

The power transmission control unit 32 receives the combination ID corresponding to the best combination from the smartphone 1. The power transmission control unit 32 executes control to apply an electric current to a coil C corresponding to the coil ID associated with the combination ID, and causes the coil C to transmit power.

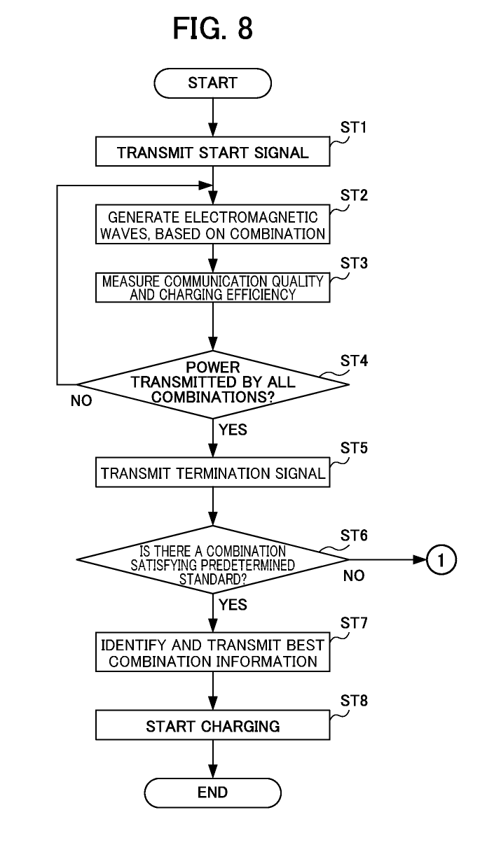

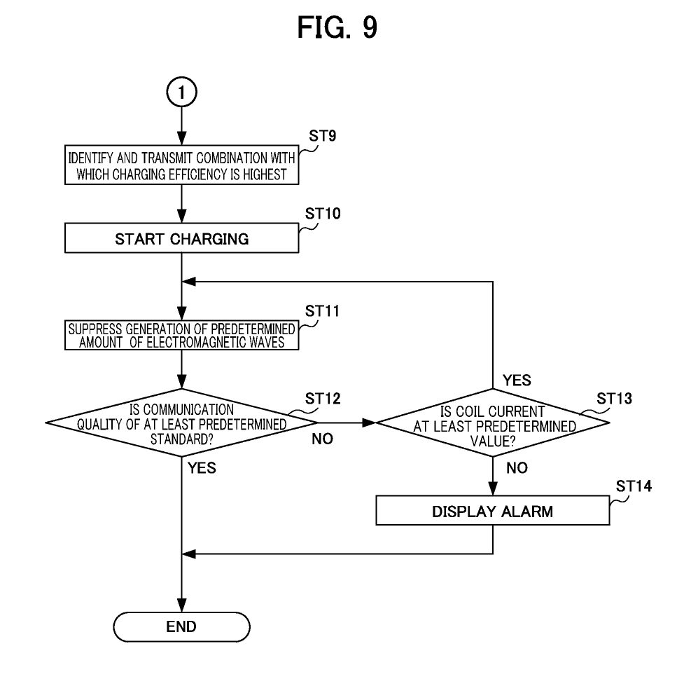

Next, with reference to flowcharts shown in FIGS. 8 and 9, descriptions are provided for a flow of charging processing by the system S. FIGS. 8 and 9 are flowcharts showing the flow of the charging processing by the system S according to the embodiment, in the reception sensitivity priority mode.

In Step ST1, when the smartphone 1 is placed on the charger BC, the power transmission control unit 32 of the charger BC transmits a start signal to the smartphone 1. More specifically, the charger BC is always generating weak electromagnetic waves, and when the smartphone 1 detects the electromagnetic waves, the smartphone 1 transmits information indicating that the smartphone 1 is proximate to the charger BC, to the charger BC. When the charger BC receives the information indicating that the smartphone 1 is proximate, the charger BC transmits a start signal to the smartphone 1.

In Step ST2, the power transmission control unit 32 of the charger BC causes some of the coils C to generate electromagnetic waves, based on the combination of the coils C stored in the storage unit 31. When an electric current is applied to some of the coils C corresponding to the combination, the power transmission control unit 32 transmits a combination ID associated with the combination to the smartphone 1.

In Step ST3, when the controller 10 of the smartphone 1 receives the combination ID, the controller 10 measures the communication quality of wireless communication of the communication unit 6, and the charging efficiency. The measurement result is temporarily stored into the storage 9.

In Step ST4, the power transmission control unit 32 determines whether the power transmission by generating electromagnetic waves has been performed for all the combinations stored in the storage unit 31. In a case in which the determination by the power transmission control unit 32 is YES, the processing advances to Step ST5. In a case in which the determination by the power transmission control unit 32 is NO, the processing returns to Step ST2.

In Step ST5, the power transmission control unit 32 transmits a termination signal to the smartphone 1.

In Step ST6, when the controller 10 receives the termination signal, the controller 10 refers to the measurement result temporarily stored in the storage 9, and determines whether there is a combination with which the quality of wireless communication satisfies a predetermined standard. In a case in which the determination by the controller 10 is YES, the processing advances to Step ST7. In a case in which the determination by the controller 10 is NO, the processing advances to Step ST9. In a case in which the determination by the controller 10 is NO, the controller 10 transmits predetermined information indicating the identified combination to the charger BC.

In Step ST7, the controller 10 identifies the best combination, and transmits combination information corresponding to the best combination to the charger BC.

In Step ST8, when the power transmission control unit 32 receives the combination information, the power transmission control unit 32 starts charging by applying an electric current to the coils C corresponding to the coil IDs associated with the combination information. When the processing in Step ST8 is completed, the controller 10 terminates the processing described in the present flow chart.

In Step ST9, the controller 10 transmits the combination information corresponding to the best combination to the charger BC.

In Step ST10, when the power transmission control unit 32 receives the combination information, the power transmission control unit 32 starts charging by applying an electric current to the coils C corresponding to the coil IDs associated with the combination information.

In Step ST11, the power transmission control unit 32 reduces the electric current applied to the coils C, thereby reducing the generation of a predetermined amount of electromagnetic waves. In a case in which the power transmission control unit 32 reduces the supply of electromagnetic waves in the plurality of coils C, the power transmission control unit 32 transmits notification information indicating that the supply of electromagnetic waves is reduced, to the smartphone 1.

In Step ST12, when the controller 10 receives the notification information, the controller 10 measures the communication quality of wireless communication of the communication unit 6, and determines whether the communication quality is of at least a predetermined standard, based on the measured amount. In a case in which the determination by the controller 10 is YES, the processing described in the present flowchart is terminated. In a case in which the determination by the controller 10 is NO, the processing advances to Step ST13. In a case in which the determination by the controller 10 is NO, the controller 10 transmits predetermined information to the charger BC.

In Step ST13, when the power transmission control unit 32 receives the predetermined information, the power transmission control unit 32 determines whether the current value applied to the coils C is at least a predetermined value. In a case in which the determination by the power transmission control unit 32 is YES, the processing returns to Step ST11. In a case in which the determination by the power transmission control unit 32 is NO, the processing advances to Step ST14. In a case in which the determination by the power transmission control unit 32 is NO, the power transmission control unit 32 transmits warning information to the smartphone 1.

In Step ST14, when the controller 10 receives the warning information from the charger BC, the controller 10 causes the touch-screen display 2 to display the warning information.

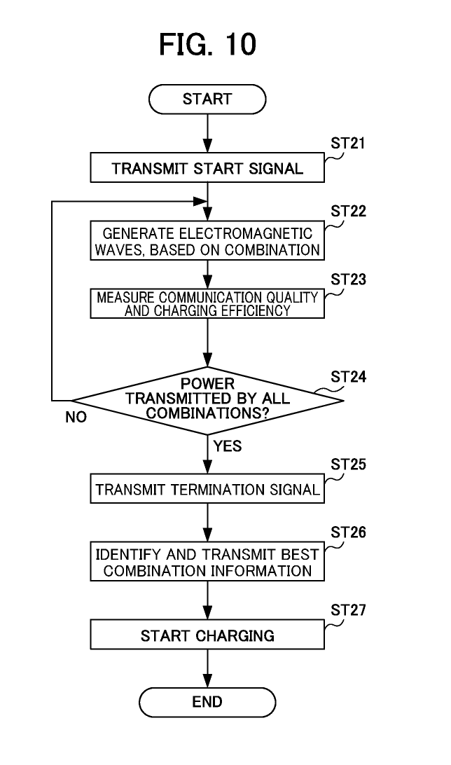

FIG. 10 is a flowchart showing a flow of the charging processing by the system S according to the embodiment, in the charging priority mode.

Since the processing in Steps ST21 to ST25 is the same as the processing in Steps ST1 to ST5 shown in the FIG. 8, descriptions thereof are omitted.

In Step ST26, the controller 10 determines the best combination with which the charging efficiency is the best, and transmits the combination information corresponding to the best combination to the charger BC.

In Step ST27, when the power transmission control unit 32 receives the combination information, the power transmission control unit 32 starts charging by applying an electric current to the coils C corresponding to the coil IDs associated with the combination information.

Therefore, the system S transmits power by using the coils C corresponding to the combination, with which the quality of wireless communication satisfies a predetermined standard, and the charging efficiency is the highest. As a result, the charger BC can transmit power without applying an electric current to the coils C deemed unnecessary for charging the smartphone 1. As a result, the system S reduces the electromagnetic waves generated by the coils C deemed unnecessary for the charging, and reduces the generation of noise in wireless communication; therefore, the system S can efficiently charge the smartphone 1 while maintaining the quality of wireless communication. The system S can switch the modes between the charge priority mode and the reception sensitivity priority mode in the smartphone 1; therefore, the user can select which of the charging or the reception sensitivity is to be prioritized, depending on the situation.

The system S includes the charger BC and the smartphone 1. The charger BC includes the plurality of coils C that transmit power through electromagnetic waves. The smartphone 1 includes the power receiving unit 18, the communication unit 6, and the storage 9. The power receiving unit 18 receives power transmitted from the coils C. The communication unit 6 communicates with a base station. The storage 9 stores information of the communication quality of the communication unit 6 with the base station, when the power receiving unit 18 is receiving power. Based on the information of the communication quality stored in the storage 9, the smartphone 1 selects, from among the plurality of coils C, a combination of the coils C for transmitting power. The charger BC transmits power by the coils C, based on the selection by the smartphone 1.

In the system S, the smartphone 1 selects a combination of the coils C with which the communication quality is of at least a predetermined standard.

In the system S, in a case in which there are a plurality of combinations of the coils C with which the communication quality is of at least a predetermined standard, the smartphone 1 selects a combination with which the communication quality is the best.

In the system S, in a case in which there is no combination of the coils C with which the communication quality is of at least a predetermined standard, the smartphone 1 selects a combination with which the communication quality is the best, among the combinations with which the communication quality is below the predetermined standard.

In the system S, the smartphone 1 includes the touch-screen display 2 that notifies (displays) that the communication quality is deteriorated, in a case in which there is no combination of the coils C with which the communication quality is of at least a predetermined standard.

In the system S, in a case in which there is no combination of the coils C with which the communication quality is of at least a predetermined standard, the smartphone 1 instructs the charger BC to reduce the amount of the power transmission from the coils C.

The system S includes the charger BC and the smartphone 1. The charger BC includes the plurality of coils C that transmit power through electromagnetic waves. The smartphone 1 includes the power receiving unit 18, the communication unit 6, and the storage 9. The power receiving unit 18 receives the power transmitted from the coils C. The communication unit 6 communicates with a base station. The storage 9 stores information of the communication quality of the communication unit 6 with the base station, when the power receiving unit 18 is receiving power. Based on the power charging efficiency in the power receiving unit 18, and based on the information of the communication quality stored in the storage 9, the smartphone 1 selects, from among the plurality of coils C, a combination of the coils C for transmitting power. The charger BC transmits power by the coils C, based on the selection by the smartphone 1.

In the system S, the smartphone 1 selects a combination of the coils C, with which the charging efficiency is at least a predetermined efficiency, and the communication quality is of at least a predetermined standard.

In the system S, in a case in which there are a plurality of combinations of the coils C, with which the charging efficiency is at least the predetermined efficiency, and the communication quality is of at least the predetermined standard, the smartphone 1 selects a combination with which the communication quality is the best among the combinations.

In the system S, in a case in which there are a plurality of combinations of the coils C, with which the charging efficiency is at least the predetermined efficiency, and the communication quality is of at least the predetermined standard, the smartphone 1 selects a combination with which the charging efficiency is the best among the combinations.

In the system S, in a case in which there is no combination of the coils C, with which the charging efficiency is at least the predetermined efficiency, and the communication quality is of at least the predetermined standard, the smartphone 1 selects a combination with which the communication quality is the best, among the combinations with which the communication quality is below the predetermined standard.

In the system S, the smartphone 1 includes the touch-screen display 2 that notifies (displays) that the communication quality is deteriorated, in a case in which there is no combination of the coils C, with which the charging efficiency is at least the predetermined efficiency, and the communication quality is of at least a predetermined standard.

The system S includes the charger BC and the smartphone 1. The charger BC includes the plurality of coils C that transmit power through electromagnetic waves. The smartphone 1 includes the power receiving unit 18, the communication unit 6, and the storage 9. The power receiving unit 18 receives power transmitted from the coils C. The communication unit 6 communicates with a base station. The storage 9 stores information of the communication quality of the communication unit 6 with the base station, when the power receiving unit 18 is receiving power. The smartphone 1 transmits the information of the communication quality stored in the storage 9 to the charger BC. The charger BC transmits power by the coils C, based on the information from the smartphone 1.

The system S includes the charger BC and the smartphone 1. The charger BC includes the plurality of coils C that transmit power through electromagnetic waves. The smartphone 1 includes the power receiving unit 18, the communication unit 6, and the storage 9. The power receiving unit 18 receives power transmitted from the coils C. The communication unit 6 communicates with a base station. The storage 9 stores information of the communication quality of the communication unit 6 with the base station, when the power receiving unit 18 is receiving power. The smartphone 1 transmits the power charging efficiency in the power receiving unit 18, and the information of the communication quality stored in the storage 9, to the charger BC. The charger BC transmits power by the coils C, based on the information from the smartphone 1.

The smartphone 1 includes the power receiving unit 18, the communication unit 6, the storage 9, the controller 10, and the coils. The power receiving unit 18 receives power transmitted through electromagnetic waves from the charger BC including the plurality of coils C. The communication unit 6 communicates with a base station. The storage 9 stores information of the communication quality of the communication unit 6 with the base station, when the power receiving unit 18 is receiving power. Based on the information of the communication quality stored in the storage 9, the controller 10 selects, from among the plurality of coils C, a combination of the coils C for transmitting power. The coils transmit the combination selected by the controller 10 to the charger BC.

The smartphone 1 includes the power receiving unit 18, the communication unit 6, the storage 9, the controller 10, and the coils. The power receiving unit 18 receives power transmitted through electromagnetic waves from the charger BC including the plurality of coils C. The communication unit 6 communicates with a base station. The storage 9 stores information of the communication quality of the communication unit 6 with the base station, when the power receiving unit 18 is receiving power. Based on the power charging efficiency in the power receiving unit 18, and based on the information of the communication quality stored in the storage 9, the controller 10 selects, from among the plurality of coils C, a combination of the coils C for transmitting power. The coils transmit the combination selected by the controller 10 to the charger BC.

A part or all of the programs stored in the storage 9 as described in FIG. 5 may be downloaded from other devices through wireless communication by the communication unit 6. A part or all of the programs stored in the storage 9 as described in FIG. 5 may be stored in a storage medium that is readable by a reader included in the storage 9. A part or all of the programs stored in the storage 9 as described in FIG. 5 may be stored in a storage medium such as a CD, a DVD or a Blu-ray that is readable by a reader connected to the external interface 14.

The configuration of the smartphone 1 shown in FIG. 5 is an example, and may be altered as appropriate within a scope that does not depart from the spirit of the present invention. For example, the number and type of the button(s) 3 are not limited to the example shown in FIG. 5. For example, the smartphone 1 may include buttons with a numeric keypad layout or a QWERTY keyboard layout, in place of the buttons 3A to 3C, as buttons for operations regarding screens. The smartphone 1 may include only a single button and need not include any button, for operations regarding screens. In the example shown in FIG. 5, the smartphone 1 includes two cameras, but the smartphone 1 may include only a single camera, or need not include any camera. In the example shown in FIG. 5, the smartphone 1 includes three types of sensors for detecting the position and posture, but the smartphone 1 need not include some of these sensors, and may include other types of sensors for detecting the position and posture. The illuminance sensor 4 and the proximity sensor 5 may be configured as a single sensor instead of separate sensors.

A characteristic embodiment has been described for the purpose of completely and clearly disclosing the present invention. However, the present invention is not to be limited to the above embodiment, and the invention is to be configured to embody all modifications and substitutable configurations that can be created by a person skilled in the art within the scope of the basic matter described herein.

For example, each program shown in FIG. 5 may be divided into a plurality of modules, and may be coupled with other programs.

In the above embodiment, a plurality of patterns for combinations of six adjacent coils are prepared in advance, and the best combination is identified by measuring the communication quality and the charging efficiency in all the patterns; however, the present invention is not limited thereto. A plurality of combinations with different numbers of adjacent coils C may be stored into the storage unit 31 in advance, and the power transmission control unit 32 may sequentially transmit power from the combinations in descending order of the number of adjacent coils C included in the combinations. In the above embodiment, the smartphone 1 identifies (instructs) the combinations; however, the charger BC may identify (instruct) combinations.

In the above embodiment, the smartphone has been described as an example of the electronic device; however, the electronic device of the present invention is not limited to a smartphone. For example, the electronic device of the present invention may be any electronic device including a power receiving unit that receives electromagnetic waves that are supplied from a charger by electromagnetic induction, and may be an electronic device such as a mobile phone, a portable personal computer, a digital camera, a media player, an electronic book reader, a navigator or a gaming machine.

### Second Embodiment

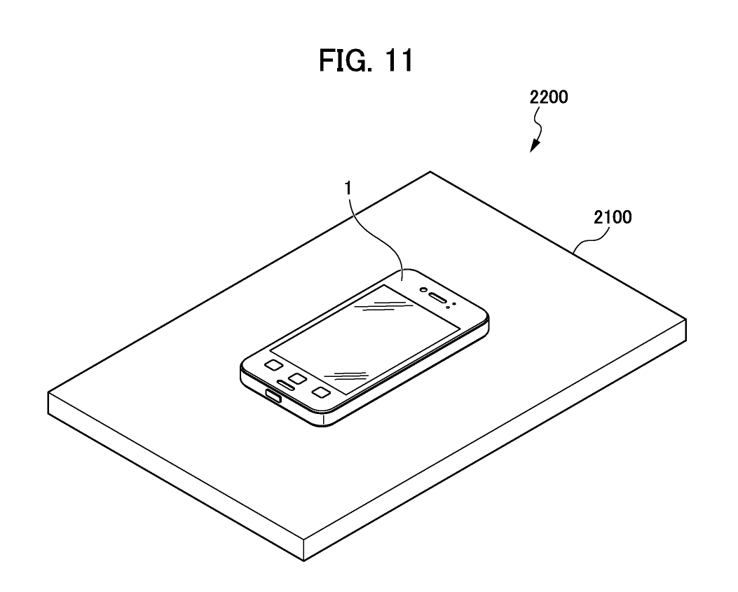

As shown in FIG. 11, a system 2200 is configured by a smartphone 1 and a contactless charger 2100. The charger 2100 will be described later.

An external appearance of the smartphone 1 of the present embodiment is similar to the external appearance of the smartphone 1 shown in FIGS. 1 to 3. An example of a screen displayed on a display 2A of the smartphone 1 of the present embodiment is similar the example shown in FIG. 4.

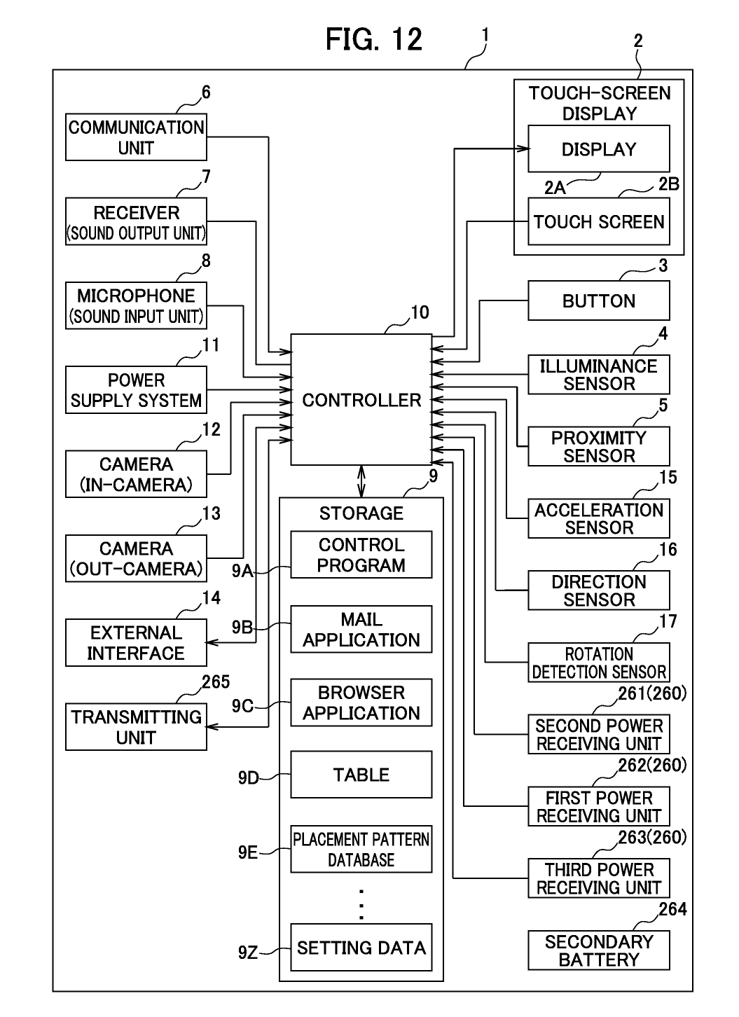

FIG. 12 is a block diagram showing a configuration of the smartphone 1. The smartphone 1 has a touch-screen display 2, a button 3, an illuminance sensor 4, a proximity sensor 5, a communication unit 6, a receiver 7, a microphone 8, a storage 9, a controller 10, cameras 12 and 13, an external interface 14, an acceleration sensor 15, a direction sensor 16, and a rotation detection sensor 17. The configuration of the touch-screen display 2, the button 3, the illuminance sensor 4, the proximity sensor 5, the communication unit 6, the receiver 7, the microphone 8, the storage 9, the controller 10, the cameras 12 and 13, the external interface 14, the acceleration sensor 15, the direction sensor 16, and the rotation detection sensor 17 is similar to the configuration shown in FIG. 5; therefore, descriptions thereof are omitted. Here, the storage 9 stores address book information including a plurality of address information items.

The smartphone 1 can perform communication even while charged by receiving power through electromagnetic waves. Descriptions are hereinafter provided for a specific configuration.

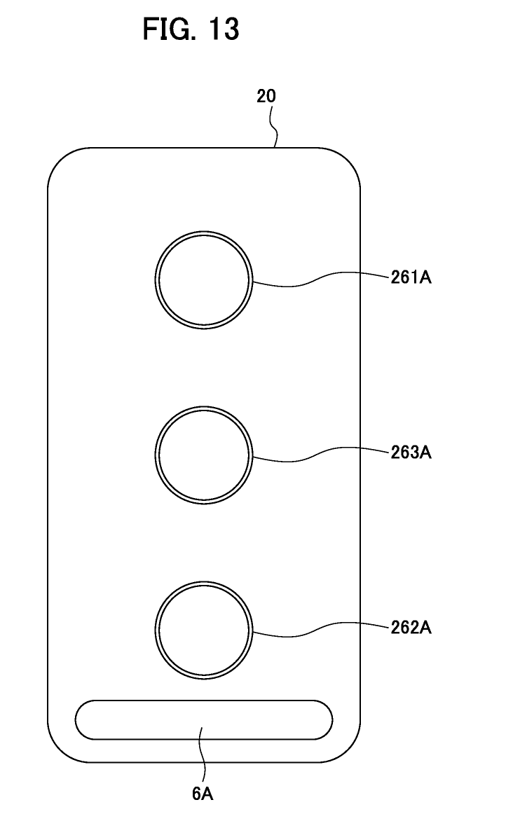

FIG. 13 is a diagram for illustrating coils included in an antenna unit 6A and a power receiving unit 260. The smartphone 1 includes the antenna unit 6A (see FIG. 13), a plurality of power receiving units 260 (261, 262, 263) (see FIG. 12), a secondary battery 264, and a transmitting unit 265.

The antenna unit 6A transmits or receives first electromagnetic waves that are used for communication. The antenna unit 6A is provided to the communication unit 6 described above. Therefore, the antenna unit 6A transmits or receives the first electromagnetic waves with a frequency defined in the wireless communication standard described above.

The plurality of power receiving units 260 are configured by, for example, a second power receiving unit 261, a first power receiving unit 262, and a third power receiving unit 263. The number of the power receiving units 260 is not limited to three. The power receiving unit 260 receives power through second electromagnetic waves that are used for the charging. More specifically, the power receiving units 261, 262 and 263 include coils 261A, 262A and 263A, respectively, which receive power through the second electromagnetic waves (see FIG. 13).

In the present embodiment, the plurality of coils 261A, 262A and 263A are disposed along a direction separating from the antenna unit 6A. In the present embodiment, the second coil 261A disposed in a position away from the antenna unit 6A is provided to the second power receiving unit 261. The first coil 262A disposed in a position close to the antenna unit 6A is provided to the first power receiving unit 262. The third coil 263A disposed between the second coil 261A and the first coil 262A is provided to the third power receiving unit 263. The positions of disposing the second coil 261A, the first coil 262A and the third coil 263A are not limited to the positions shown in FIG. 13.

When the power receiving unit 260 receives power through the second electromagnetic waves, the power receiving unit 260 converts the second electromagnetic wave into power, and charges the secondary battery 264 (see FIG. 12). The secondary battery 264 is charged by the power receiving unit 260 receiving power through the second electromagnetic waves. The second electromagnetic waves are output from the charger 2100 to be described later.

In a case in which the antenna unit 6A transmits or receives the first electromagnetic waves, the controller 10 (a first control unit) described above can control the second power receiving unit 261 (the second coil 261A), which is separated from the antenna unit 6A among the plurality of power receiving units 260, to receive power through the second electromagnetic waves. In other words, in a case in which the antenna unit 6A transmits or receives the first electromagnetic waves, the first power receiving unit 262 (the first coil 262A) and the third power receiving unit 263 (the third coil 263A) do not receive power through the second electromagnetic waves.

According to the smartphone 1 as described above, the second power receiving unit 261 as the power receiving unit (coil) separated from the antenna unit 6A (the second coil 261A) receives power through the second electromagnetic waves; therefore, even in a case in which noise occurs due to the second power receiving unit 261 (the second coil 261A) receiving power through the second electromagnetic waves, it is possible to reduce the adverse effects of noise on the characteristics of the antenna unit 6A.

In a case in which the second power receiving unit 261 (the second coil 261A) receives power through the second electromagnetic waves, the transmitting unit 265 transmits a control signal for causing a power transmitting unit 2101 (to be described later) to transmit power through the second electromagnetic waves from a position facing the second power receiving unit 261 (the second coil 261A), to the charger 2100 (to be described later). In other words, based on the control by the controller 10, the transmitting unit 265 transmits the control signal for controlling the power transmitting unit 2101 to increase the intensity of the second electromagnet waves received by the second power receiving unit 261 (the second coil 261A). As a result of such control, the amount of the electromagnetic waves arriving at the antenna unit 6A is reduced.

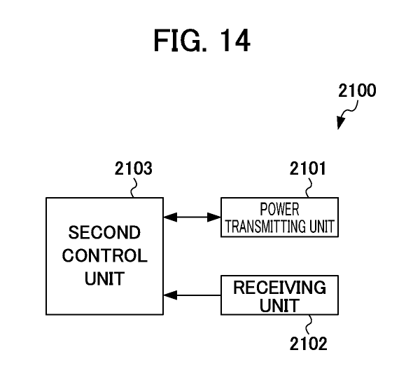

Here, descriptions are provided for the charger 2100. FIG. 14 is a block diagram showing functions of the charger 2100. The charger 2100 is a contactless charger 2100 being capable of charging the smartphone 1 without using a charger cable. The charger 2100 as described above includes a power transmitting unit 2101, a receiving unit 2102, and a second control unit 2103.

The power transmitting unit 2101 transmits power through the second electromagnetic waves to the power receiving unit 260. More specifically, the power transmitting unit 2101 includes a coil (not shown) that transmits power through the second electromagnetic waves. Here, the power transmitting unit 2101 includes a single or plurality of coils. In a case in which the power transmitting unit 2101 includes a single coil, the coil can move along a planer direction of the charger 2100. The charger 2100 as described above is a charger 2100 of a moving-coil scheme. On the other hand, in a case in which the power transmitting unit 2101 includes a plurality of coils, each coil is fixed to the charger 2100. In a case in which the power transmitting unit 2101 transmits power through the second electromagnetic waves, the power transmitting unit 2101 causes at least one of the plurality of coils to transmit power through the second electromagnetic waves. The charger 2100 as described above is a charger 2100 of a multi-coil scheme.

When the smartphone 1 transmits a control signal for controlling the transmitting unit 2101, the receiving unit 2102 receives the control signal. When the receiving unit 2102 receives the control signal, the receiving unit 2102 supplies the control signal to the second control unit 2103.

In a case in which the antenna unit 6A transmits or receives the first electromagnetic waves, the second control unit 2103 can control the power transmitting unit 2101 to transmit power through the second electromagnetic waves to the second power receiving unit 261. More specifically, in a case in which the charger 2100 is of the moving-coil scheme, when the second power receiving unit 261 (the second coil 261A) receives power through the second electromagnetic waves due to the antenna unit 6A transmitting or receiving the first electromagnetic waves, the second control unit 2103 moves the coil of the power transmitting unit 2101 to a position facing the second power receiving unit 261 (the second coil 261A), based on the control signal. On the other hand, in a case in which the charger 2100 is of the multi-coil scheme, when the second power receiving unit 261 (the second coil 261A) receives power through the second electromagnetic waves due to the antenna unit 6A transmitting or receiving the first electromagnetic waves, the second control unit 2103 causes the coil of the power transmitting unit 2101 disposed in a position facing the second power receiving unit 261 (the second coil 261A) to transmit power through the second electromagnetic waves, based on the control signal.

According to the charger 2100 as described above, the distance between the power transmitting unit 2101 transmitting power through the second electromagnetic waves and the antenna unit 6A of the smartphone 1 is relatively increased; therefore, even in a case in which noise is generated due to the power transmitting unit 2101 transmitting power through the second electromagnetic waves, it is possible to reduce the adverse effects of noise on the characteristics of the antenna unit 6A.

As described above, with the system 2200 including the smartphone 1 and the charger 2100, even in a case in which the secondary battery 264 of the smartphone 1 is being charged by receiving power through the second electromagnetic waves, it is possible to reduce the adverse effects on the communication performed by the smartphone 1.

The embodiment has been described above for a case in which the transmitting unit 265 of the smartphone 1 transmits a control signal that is then received by the receiving unit 2102 of the charger 2100. As a modification example thereof, any one of the plurality of power receiving units 260 can transmit a control signal than can be then received by the power transmitting unit 2101. In other words, the plurality of power receiving units 260 can transmit the third electromagnetic waves as a signal (control signal) for causing the power transmitting unit 2101 to transmit power through the second electromagnetic waves from a position facing the second power receiving unit 261. The power transmitting unit 2101 can receive the third electromagnetic waves. The frequency of the third electromagnetic waves is different from the frequency of the second electromagnetic waves.

Regarding the mode when the power receiving unit 260 receives power through the second electromagnetic waves, the controller 10 may be allowed to set the mode to a power receiving priority mode or a communication priority mode.

The power receiving priority mode is a mode in which the power receiving efficiency is favorable, since the number of power receiving units is greater than that in the other modes, and for example, at least two power receiving units 260 receive power through the second electromagnetic waves. For example, the power receiving priority mode is a mode in which the first power receiving unit 262 and the third power receiving unit 263 receive power through the second electromagnetic waves; or the second power receiving unit 261 and the third power receiving unit 263 receive power through the second electromagnetic waves; or the second power receiving unit 261, the first power receiving unit 262 and the third power receiving unit 263 receive power through the second electromagnetic waves. In a case in which the first power receiving unit 262 and the third power receiving unit 263 receive power through the second electromagnetic waves, the single or a plurality of power transmitting units 2101 transmit power through the second electromagnetic waves from a position facing the first power receiving unit 262 and the third power receiving unit 263. In a case in which the second power receiving unit 261 and the third power receiving unit 263 receive power through the second electromagnetic waves, the single or plurality of power transmitting units 2101 transmit power through the second electromagnetic waves from a position facing the second power receiving unit 261 and the third power receiving unit 263. In a case in which the second power receiving unit 261, the first power receiving unit 262 and the third power receiving unit 263 receive power through the second electromagnetic waves, the single or plurality of power transmitting units 2101 transmit power through the second electromagnetic waves from a position facing the second power receiving unit 261, the first power receiving unit 262 and the third power receiving unit 263.

The communication priority mode is a mode in which the second power receiving unit 261 receives power through the second electromagnetic waves, without the first power receiving unit 262 receiving the second electromagnetic waves. In a case in which the mode is set to the communication priority mode, the power transmitting unit 2101 transmits power through the second electromagnetic waves from a position facing the second power receiving unit 261.

In a case in which the mode is set to the power receiving priority mode, the controller 10 allows the first power receiving unit 262 to receive power through the second electromagnetic waves, even when the antenna unit 6A transmits or receives the first electromagnetic waves.

As a result, in a case in which the mode is set to the power receiving priority mode, the system 2200 including the smartphone 1 and the charger 2100 can select the power receiving unit 260 with a higher efficiency of receiving power through the second electromagnetic waves. In a case in which the user selects the power receiving priority mode or the communication priority mode, the system 2200 can select the power receiving unit 260 that is suitable for the selected mode.

In a case in which the remaining battery level of the secondary battery 264 is below a preset first threshold value, it is preferable for the controller 10 to set the mode to the power receiving priority mode. In other words, if the remaining battery level of the secondary battery 264 runs out, adverse effects such as disconnection of the communication using the communication unit 6 occur to the smartphone 1. Therefore, in a case in which the remaining battery level of the secondary battery 264 is relatively low, the controller 10 sets the mode to the power receiving priority mode described above, in order to avoid running out of the remaining battery level. In a case in which the mode is set to the power receiving priority mode, the smartphone 1 selects the power receiving unit 260 whose efficiency of receiving power through the second electromagnetic waves is favorable; more specifically, the smartphone 1 selects the first power receiving unit 262. In the charger 2100, the power transmitting unit 2101 disposed in a position facing the selected power receiving unit 260 transmits power through the second electromagnetic waves.

The remaining battery level is measured by way of a voltage value at the terminals of the secondary battery 264, or by way of a balance of electric currents that are input/output into/from the secondary battery 264.

As a result, the system 2200 including the smartphone 1 and the charger 2100 can restore the remaining battery level of the secondary battery 264.

In a case in which the power receiving unit 260 receives power through the second electromagnetic waves, when the RSSI (Received Signal Strength Indication) value of the first electromagnetic waves received by the antenna unit 6A is below a preset second threshold value, it is preferable for the controller 10 to cause only the second power receiving unit 261 to receive power through the second electromagnetic waves.

In other words, in a case in which the RSSI value is greater than the second threshold value, the environment of radio waves transmitted and received by the antenna unit 6A is favorable; therefore, the communication can be continued even if noise occurs due to the power receiving unit 260 and the power transmitting unit 2101. On the other hand, in a case in which the RSSI value is below the second threshold value, the environment of radio waves transmitted and received by the antenna unit 6A is deteriorated; therefore, it is difficult to continue the communication if noise occurs due to the power receiving unit 260 and power transmitting unit 2101.

Therefore, in a case in which the RSSI value is below the second threshold value, the controller 10 sets the mode to the communication priority mode, and causes the second power receiving unit 261 to receive power through the second electromagnetic waves. The second control unit 2103 causes the power transmitting unit 2101 disposed in a position facing the second power receiving unit 261 to transmit power through the second electromagnetic waves, based on the control signal transmitted from the smartphone 1.

As a result, since the system 2200 including the smartphone 1 and the charger 2100 can reduce the adverse effects of noise, which is generated in the power receiving unit 260 and the power transmitting unit 2101, on the characteristics of the antenna unit 6A, the system 2200 can continue the communication of the smartphone 1 even while the secondary battery 264 is being charged.

It is preferable for the smartphone 1 to further include a second antenna unit utilized for contactless communication. In other words, in a case in which the smartphone 1 has, for example, an IC (Integrated Circuit) card function such as FeliCa (registered trademark), the second antenna unit transmits and receives data utilized for the IC card function.

One of the plurality of power receiving units 260 configures the second antenna unit described above. A circuit (not shown) utilized for the IC card function and a circuit (not shown) utilized for the charging are connected to the second antenna unit, and the circuits are switched by, for example, a switch unit (not shown). In other words, in a case in which the charging is not performed, the switch unit connects the second antenna unit to the circuit utilized for the IC card function. On the other hand, in a case in which the charging is performed, the switch unit connects the second antenna unit to the circuit utilized for the charging.

As a result, since the second antenna unit can be shared, the smartphone 1 can be downsized as compared to a case in which the antenna for the IC card function is separately provided in addition to the power receiving unit 260.

It is preferable for the smartphone 1 to further include a temperature measuring unit (not shown) that measures respective temperatures of the plurality of power receiving units 260. The temperature measuring unit is, for example, a thermistor. In this case, the controller 10 causes the power receiving unit 260, whose temperature measured by the temperature measuring unit is lower than the temperatures of the plurality of power receiving units 260, to receive power through the second electromagnetic waves.

For example, in a case in which the controller 10 sets the mode to the power receiving priority mode, the controller 10 causes the single or plurality of power receiving units 260, whose temperature measured by the temperature measuring unit is lower, to receive power through the second electromagnetic waves. In this case, the power transmitting unit 2101 transmits power through the second electromagnetic waves from a position facing the power receiving unit 260 that receives power through the second electromagnetic waves, based on the control by the second control unit 2103.

In a case in which the temperature of the power receiving unit 260 rises due to receiving power through the second electromagnetic waves, the controller 10 causes the power receiving unit 260, whose temperature measured by the temperature measuring unit is lower, to receive power through the second electromagnetic waves, among the other power receiving units 260 except for the power receiving unit 260 whose temperature rose. In other words, the controller 10 switches the power receiving units 260 for receiving power through the second electromagnetic waves. In this case, the power transmitting unit 2101 transmits power through the second electromagnetic waves from a position facing the power receiving unit 260 thus switched, based on the control by the second control unit 2103.

By repeating the processing exemplified above, the system 2200 including the smartphone 1 and the charger 2100 can charge the secondary battery 264 with power through the second electromagnetic waves received by the power receiving unit 260 whose temperature is lower.

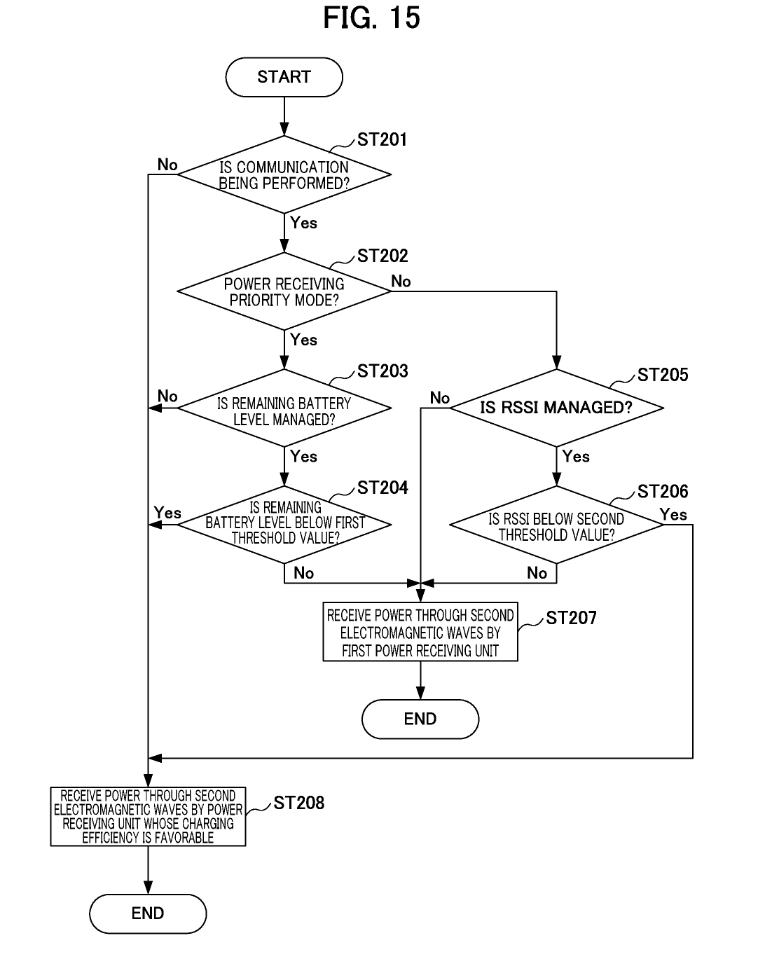

Next, descriptions are provided for operations for charging the secondary battery 264 of the smartphone 1. FIG. 15 is a flowchart for illustrating the operations for charging the secondary battery 264 of the smartphone 1.

In Step ST201, the controller 10 determines whether communication is currently performed by the communication unit 6. In a case in which communication is currently performed (YES), the processing advances to Step ST202. In a case in which communication is not currently performed (NO), the processing advances to Step ST208.

In Step ST202, the controller 10 determines whether the user selects the power receiving priority mode. In a case in which the power receiving priority mode is selected (YES), the processing advances to Step ST203. In a case in which the power receiving priority mode is not selected (NO), the processing advances to Step ST205.

In Step ST203, the controller 10 determines whether the user sets the remaining battery level of the secondary battery 264 to be managed. In a case in which the remaining battery level is managed (YES), the processing advances to Step ST204. In a case in which the remaining battery level is not managed (NO), the processing advances to Step ST208.

In Step ST204, the controller 10 determines whether the remaining battery level of the secondary battery 264 is below the first threshold value. In a case in which the remaining battery level is not below the first threshold value (NO), the processing advances to Step ST207. In a case in which the remaining battery level is below the first threshold value (YES), the processing advances to Step ST208.

In a case in which the determination in Step ST202 is “NO”, the controller 10 determines, in Step ST205, whether the user sets the RSSI (RSSI) to be managed. In a case in which the RSSI is managed (YES), the processing advances to Step ST206. In a case in which the RSSI is not managed (NO), the processing advances to Step ST207.

In Step ST206, the controller 10 determines whether the RSSI value is below the second threshold value. In a case in which the RSSI value is not below the second threshold value (NO), the processing advances to Step ST207. In a case in which the RSSI value is below the second threshold value (YES), the processing advances to Step ST208.

In Step ST207, the controller 10 causes the second power receiving unit 261 to receive power through the second electromagnetic waves. In this case, the second control unit 2103 causes the power transmitting unit 2101 in a position facing the second power receiving unit 261 to transmit power through the second electromagnetic waves.

In Step ST208, the controller 10 causes the power receiving unit 260 whose charging efficiency is favorable to receive power through the second electromagnetic waves. In this case, the second control unit 2103 causes the power transmitting unit 2101 in a position facing the power receiving unit 260 to transmit power through the second electromagnetic waves. For example, from among the second power receiving unit 261, the first power receiving unit 262 and the third power receiving unit 263, the controller 10 selects a combination whose efficiency of receiving power through the second electromagnetic waves is favorable, and causes the selected power receiving unit 260 to receive power through the second electromagnetic waves. In this case, the second control unit 2103 causes the power transmitting unit 2101 in a position facing the selected power receiving unit 260 to transmit power through the second electromagnetic waves.

A characteristic embodiment has been described for the purpose of completely and clearly disclosing the present invention. However, the present invention is not to be limited to the above embodiment, and the invention is to be configured to embody all modifications and substitutable configurations that can be created by a person skilled in the art within the scope of the basic matter described herein.

In the above embodiment, the smartphone has been described as an example of a device including a touch-screen display, but the device of the present invention is not limited to a smartphone. For example, the device of the present invention may be a portable electronic device such as a mobile phone, a portable personal computer, a digital camera, a media player, an electronic book reader, a navigator or a gaming machine. The device of the present invention may be a non-portable electronic device, such as a desktop PC or a television set.

In this way, the embodiment of the present invention includes the following aspects. In other words, the present invention may include the smartphone 1 and the charger 2100. The smartphone 1 includes the antenna unit 6A, the plurality of power receiving units (the first power receiving unit 262, the second power receiving unit 261, and the third power receiving unit 263), and the controller 10. The antenna unit 6A transmits or receives first electromagnetic waves that are used for communication. The plurality of power receiving units receive power through the second electromagnetic waves that are used for the charging. In a case in which the antenna unit 6A transmits or receives the first electromagnetic waves, the controller 10 controls the second power receiving unit 261 and the third power receiving unit 263, which are different from the first power receiving unit 262 being the closest to the antenna unit 6A among the plurality of power receiving units 260, to receive power through the second electromagnetic waves. The charger 2100 includes the power transmitting unit 2101 and the second control unit 2103. The power transmitting unit 2101 transmits power through the second electromagnetic waves to a part or all of the plurality of power receiving units. In a case in which the antenna unit 6A transmits or receives the first electromagnetic waves, the second control unit 2103 controls the power transmitting unit to transmit power through the second electromagnetic waves to the second power receiving unit 261 or the third power receiving unit 263.

The controller 10 includes the communication priority mode in which the antenna unit 6A transmits or receives data. In the communication priority mode, the controller 10 may use the second power receiving unit 261 and the third power receiving unit 263 to receive power through the second electromagnetic waves, instead of using the first power receiving unit 262.

In this way, in a case in which the antenna unit 6A performs communication, a power receiving unit other than the first power receiving unit 262 may perform the wireless charging, such that the electromagnetic waves from the power receiving unit are unlikely to interfere with the electromagnetic waves transmitted and received by the antenna unit 6A.

In a case in which power is received through the second electromagnetic waves, and the received signal strength of the first electromagnetic waves received by the antenna unit 6A is below the preset second threshold value, the controller 10 may set the mode to the communication priority mode to reduce further attenuation of the received signal strength of the first electromagnetic waves due to receiving power by the first power receiving unit 262.

The controller 10 may include the power receiving priority mode for giving priority to the power receiving, separately from the communication priority mode. More specifically, in the power receiving priority mode, the controller 10 may use at least two power receiving units to receive power regardless of positions of disposing the power receiving units, and may allow a larger number of power receiving units to receive the power transmitted from the charger 2100.

In a case in which the remaining battery level of the secondary battery 264 is below the preset first threshold value, the smartphone 1 may set the mode to the power receiving priority mode; and in a case in which the remaining battery level is running short, the smartphone 1 may use the plurality of power receiving units to expedite the charging.

In the communication priority mode of the smartphone 1, the communication unit 6 transmits a control signal for controlling power to be transmitted through the second electromagnetic waves toward the second power receiving unit 261 or the third power receiving unit 263. The charger 2100 receives the control signal from the receiving unit 2102. Based on the control signal, the second control unit 2103 may control the power transmitting unit to transmit power through the second electromagnetic waves toward the second power receiving unit 261 or the third power receiving unit 263.

### Third Embodiment

A smartphone 1 of the present embodiment is utilized for a guidance system 3200 that is capable of guiding the smartphone 1 to a position where the power receiving efficiency is high. Descriptions are hereinafter provided for a specific configuration.

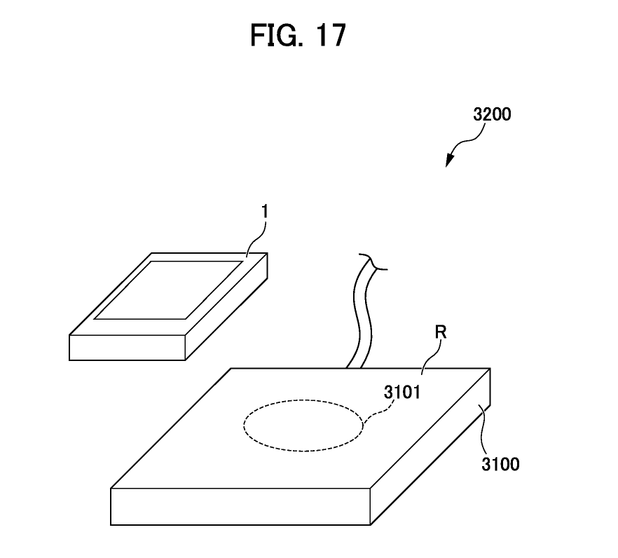

As shown in FIG. 17, the guidance system 3200 includes a charger 3100 and the smartphone 1. The guidance system 3200 has a function of executing contactless charging (wireless power feed), in which the charger 3100 wirelessly transmits power to the smartphone 1 by an electromagnetic induction scheme. The power feed scheme is not limited to the electromagnetic induction scheme, and a radio wave transmitting scheme, a resonance scheme or the like may be employed.

The charger 3100 includes a predetermined surface having a first area R. The charger 3100 transmits power through electromagnetic waves to the smartphone 1 (electronic device) that is placed on the first area R. The predetermined surface refers to a surface of the charger 3100. The charger 3100 internally includes a coil 3101 that is made by spirally winding a wire a plurality of times into a circular shape or a rectangular shape. The charger 3100 outputs a magnetic field from the coil 3101.

An external appearance of the smartphone 1 of the present embodiment is similar to the external appearance of the smartphone 1 shown in FIGS. 1 to 3. An example of a screen displayed on a display 2A of the smartphone 1 of the present embodiment is similar the example shown in FIG. 4.

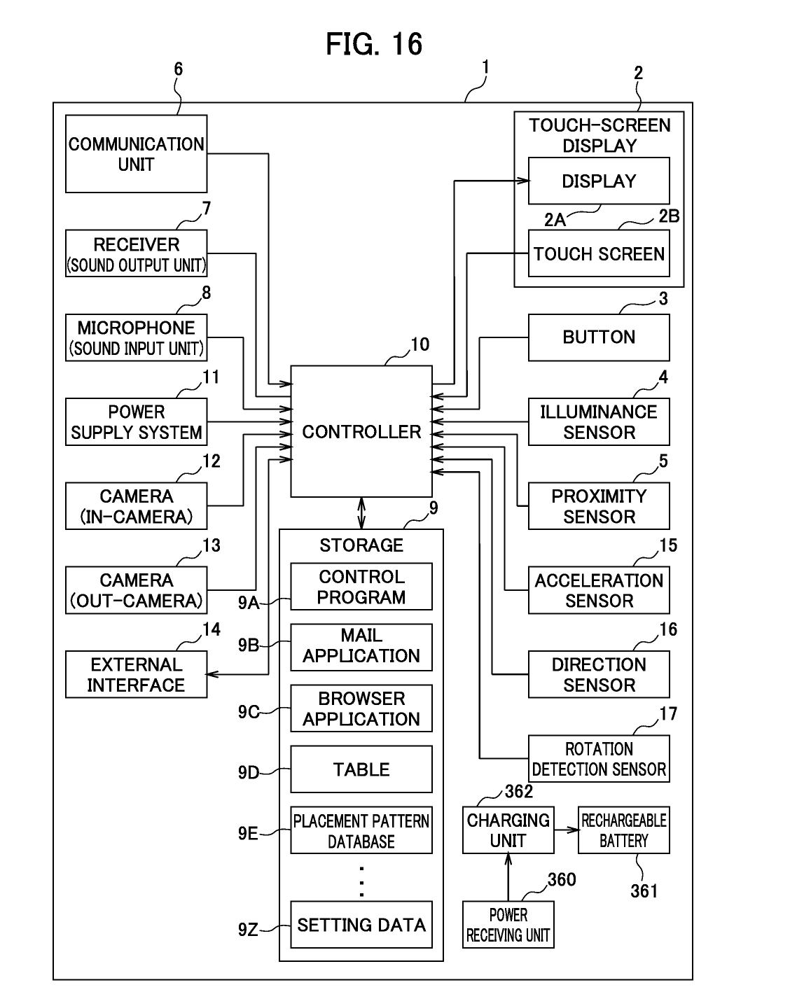

FIG. 16 is a block diagram showing a configuration of the smartphone 1. The smartphone 1 has a touch-screen display 2, a button 3, an illuminance sensor 4, a proximity sensor 5, a communication unit 6, a receiver 7, a microphone 8, a storage 9, a controller 10, a cameras 12 and 13, an external interface 14, an acceleration sensor 15, a direction sensor 16, and a rotation detection sensor 17. The configuration of the touch-screen display 2, the button 3, the illuminance sensor 4, the proximity sensor 5, the communication unit 6, the receiver 7, the microphone 8, the storage 9, the controller 10, the cameras 12 and 13, the external interface 14, the acceleration sensor 15, the direction sensor 16, and the rotation detection sensor 17 is similar to the configuration shown in FIG. 5; therefore, descriptions thereof are omitted.

As shown in FIG. 16, the smartphone 1 includes a power receiving unit 360, a rechargeable battery 361, and a charging unit 362. The power receiving unit 360 receives power through electromagnetic waves from the charger 3100. The power receiving unit 360 is configured by a coil that is made by spirally winding a wire a plurality of times into a circular shape or a rectangular shape. The charging unit 362 charges the rechargeable battery 361 by an electromotive force generated by electromagnetic waves received by the power receiving unit 360.

More specifically, when the smartphone 1 is proximate to the charger 3100 that is outputting a magnetic field, electromagnetic induction generates an electromotive force in the power receiving unit 360. The charging unit 362 charges the rechargeable battery 361 by the electromotive force generated in the power receiving unit 360. The charging unit 362 may include a rectifier circuit for rectifying voltage, and a stabilizing circuit.

In a case in which the power receiving unit 360 is disposed to face the first area R, the charging efficiency of the charging unit 362 is higher than a predetermined efficiency.

The power receiving efficiency in the present invention is calculated by an equation: [value of power received by the smartphone 1]÷[value of power transmitted from the charger 3100].

The “value of power received by the smartphone 1” may be, for example: the value of power received by the power receiving unit 360; the value of power measured at terminals of the rechargeable battery 361 of the smartphone 1 when the power receiving unit 360 receives power; the value of power that takes account of power loss in the power receiving unit 360; or the like.

The “value of power transmitted from the charger 3100” may be, for example: the value of power of electromagnetic waves emitted from the coils C; the value of power requested by the smartphone 1 to the charger 3100 to transmit power; or the like.

The power receiving efficiency is calculated by selecting a single value from among “values of power received by the smartphone 1”, and a single value from among “values of power transmitted from the charger 3100”.

The voltage value or the current value may be used instead of the power value.

It may be noted that if the power receiving unit 360 is not disposed to face the first area R, it is difficult for the charging unit 362 to achieve a charging (power receiving) efficiency that is higher than a predetermined efficiency. Therefore, it is necessary to guide the power receiving unit 360 and the first area R to positions facing each other.

The camera 13 ordinarily captures an object within a predetermined image capturing range centering on a normal direction. If the power receiving unit 360 is disposed to surround the camera 13, inside the body, the following method can guide the power receiving unit 360 and the first area R to positions facing each other.

When power is received by the wireless power feed, the camera 13 is activated, the display 2A displays an image captured by the camera 13, and guidance may be provided such that the charger 3100 appears in a central position of the captured image (a position in the normal direction of the camera 13).

On the other hand, as in the present embodiment, in a case in which the position of disposing the camera 13 is different from the position of disposing the power receiving unit 360, favorable guidance cannot be provided by the above method.

Accordingly, with the following configuration, the smartphone 1 is guided to a position where the power receiving efficiency is high.

As described above, the smartphone 1 includes the camera 13 (the image capturing unit) and the controller 10 (the control unit). The controller 10 calculates the relative position of the power receiving unit 360 in relation to the position of the charger 3100, based on an image of the charger 3100 captured by the camera 13 (for example, an image of an external appearance of the charger 3100). The controller 10 recognizes the charger 3100 based on an image captured by the camera 13, by utilizing an image recognition technology. For example, the controller 10 extracts characteristics of the image captured by the camera 13, compares the image with a reference pattern of the charger 3100, and determines whether a predetermined concordance rate is obtained, thereby recognizing the charger 3100.

In this manner, the guidance system 3200 calculates the relative position of the power receiving unit 360 in relation to the position of the first area R, i.e. the relative position of the first area R on the basis of the position where the power receiving unit 360 is disposed; therefore, the guidance system 3200 can provide guidance to a position where the power receiving efficiency is high, by causing the display 2A to display, for example, the relative position of the charger 3100 thus calculated.

As described above, the smartphone 1 includes the display 2A (the display unit). The controller 10 may be configured to cause the display 2A to display a reference image based on a position where the power receiving unit 360 is disposed, and a target image based on a position relative to a calculated position of the charger 3100.

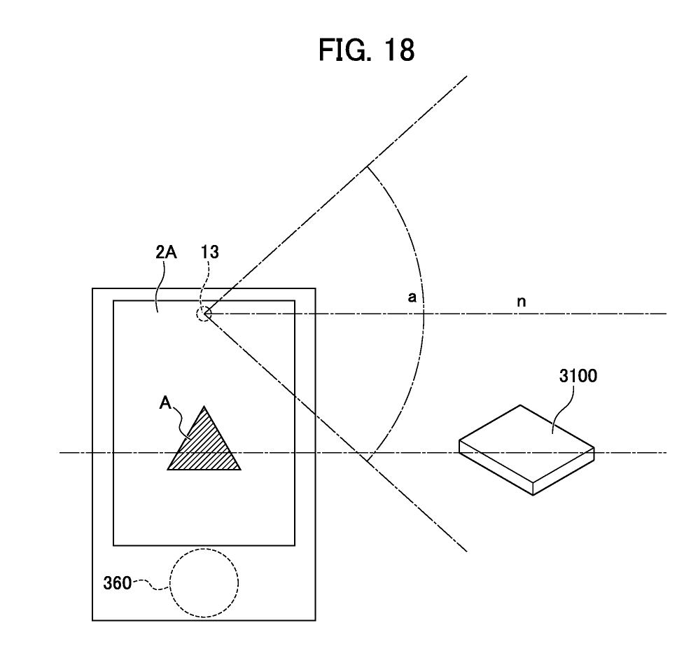

More specifically, as shown in FIG. 18, the controller 10 causes the display 2A to display a reference image A in the center of the display 2A. The reference image A is fixedly displayed in the central position of the display 2A, and the reference image A does not move even if the smartphone 1 is moved. The position of displaying the reference image A is not limited to the center of the display 2A. As shown in FIG. 18, the camera 13 captures an object within a predetermined image capturing range centering on a normal line n.

At the designing stage, the positions of disposing the camera 13 and the power receiving unit 360 within the smartphone are already known; therefore, the positions of disposing the camera 13 and the power receiving unit 360 are stored into the storage 9 in advance.

Based on the image of the charger 3100 captured by the camera 13, the controller 10 calculates the position of the charger 3100 in the reference image A. In the example shown in FIG. 18, the controller 10 calculates that the charger 3100 appears in the vicinity of the center of the reference image A.

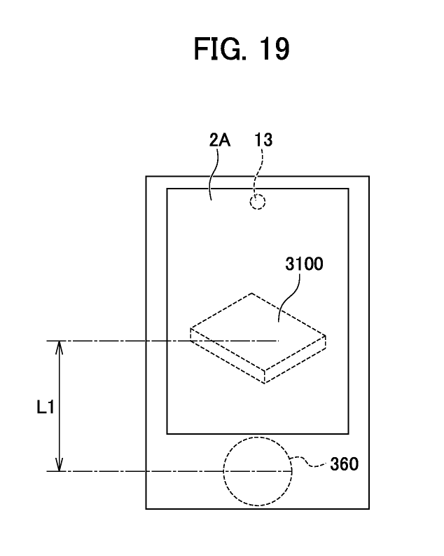

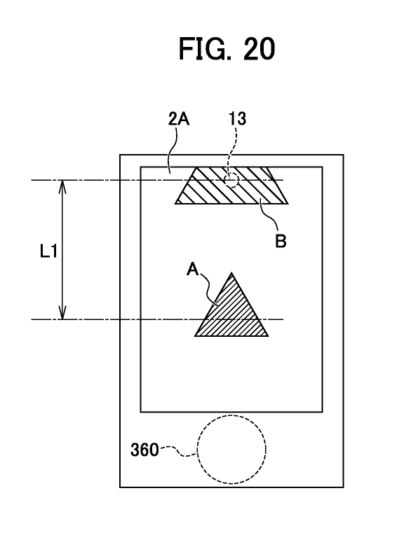

The controller 10 calculates a displacement value L1 that is the difference between the calculated position of the charger 3100 in the image, and the position where the power receiving unit 360 is disposed (see FIG. 19). In the present embodiment, when the displacement value L1 is calculated, the controller 10 does not cause the display 2A to display an image including the charger 3100; however, the present invention is not limited thereto. Based on the displacement value L1, the controller 10 displays a target image B in a position displaced from the reference image A by the displacement value L1 (see FIG. 20).

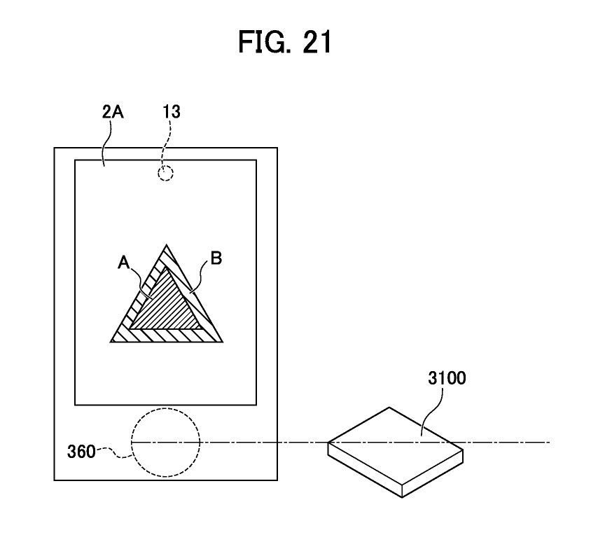

In accordance with a guidance instruction, the user moves the smartphone 1 such that the reference image A overlaps with the target image B. When the reference image A overlaps with the target image B, the power receiving unit 360 faces the first area R (see FIG. 21). In this manner, by placing the smartphone 1 in the position where the reference image A overlaps with the target image B, the smartphone 1 can receive power in a position where the receiving efficiency is high. In addition to displaying the reference image A and the target image B, the smartphone 1 may display a message for providing guidance such that the reference image A overlaps with the target image B.

The target image B may be configured to change its size in accordance with the distance between the smartphone 1 and the charger 3100. For example, the controller 10 causes the display to display the target image B smaller as the smartphone 1 is separated from the charger 3100, and to display the target image B larger as the smartphone 1 is closer to the charger 3100.

The controller 10 may be configured to manage the travel distance of the smartphone 1 by utilizing the acceleration sensor 15, the rotation detection sensor 17 or the like, and to guide the smartphone 1 to a correct position.

In this manner, since the guidance system 3200 guides the reference image A to a position overlapping with the target image B, even in a case in which the position where the camera 13 is disposed is different from the position where the power receiving unit 360 is disposed, the guidance system 3200 can guide the smartphone 1 to a position where the power receiving efficiency is high.

FIGS. 18, 19, 20 and 21 schematically show the camera 13 and the power receiving unit 360 in a transparent manner, for the convenience of illustration.

The guidance may also be reported by, for example, sound, etc. in addition to the displaying.

The controller 10 may be configured to generate a polygon in a predetermined color as the reference image A, to generate another polygon in a color different from the predetermined color as the target image B, and to cause the display 2A to display the reference image A and the target image B.

With such a configuration, the guidance system 3200 can guide the reference image A to a position overlapping with the target image B in a visually comprehensible manner.

The predetermined surface of the charger 3100 may be configured to be marked with a mark indicating the position of the coil 3101 that transmits electromagnetic waves. The controller 10 calculates the relative position, based on a position of the mark captured by the camera 13, and the position of the power receiving unit 360.

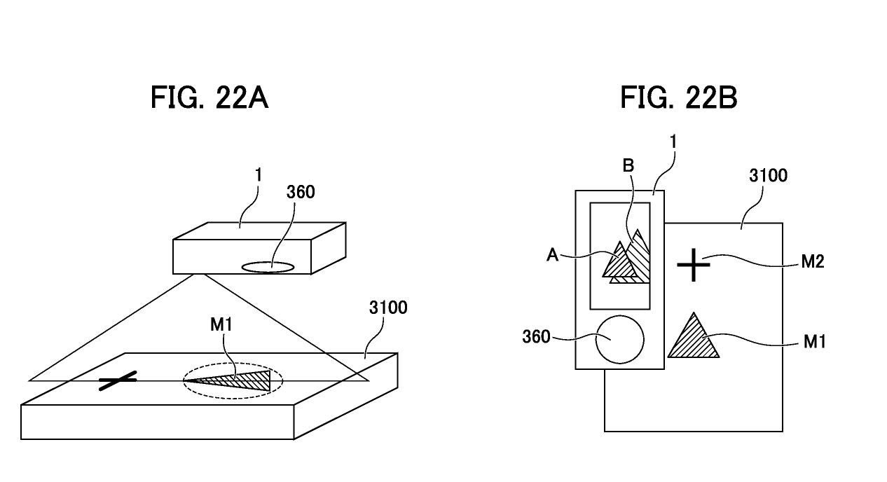

More specifically, as shown in FIG. 22, a mark M1 indicating the position of the built-in coil 3101 is printed on the surface of the charger 3100.

The controller 10 determines whether the mark M1 is included in the image captured by the camera 13, and in a case of determining that the mark M1 is included, the controller 10 calculates the relative position of the charger 3100 based on the mark M1, on the basis of the position where the power receiving unit 360 is disposed. For example, the controller 10 extracts characteristics of the image captured by the camera 13, compares the image with a reference pattern of the mark M1, and determines whether a predetermined concordance rate is obtained, thereby recognizing the mark M1.

In a case of such a configuration, the controller 10 generates a target image, based on the mark M1.

Therefore, since the guidance system 3200 guides the target image generated based on the mark M1 to a position overlapping with the reference image, even in a case in which the position of disposing the camera 13 is different from the position of disposing the power receiving unit 360, the guidance system 3200 can guide the smartphone 1 to a position where the power receiving efficiency is high.

As shown in FIG. 22, a configuration may be employed such that a positioning mark M2 is also indicated in addition to the mark M1 showing the position of the coil 3101. With such a configuration, the controller 10 generates a target image by calculating the relative position of the charger 3100 based on the mark M2, on the basis of the position where the power receiving unit 360 is disposed. In the example shown in FIG. 22B, when the smartphone 1 is moved toward the right such that the target image B generated based on the positioning mark M2 overlaps with the reference image A, the mark M1 overlaps with a position immediately under the power receiving unit 360.

The controller 10 may be configured to manage the travel distance of the smartphone 1 by utilizing the acceleration sensor 15, the rotation detection sensor 17 or the like, and to guide the smartphone 1 to a correct position.

It may be noted that performance of a camera installed in the smartphone 1 varies, and an angle of view (image capturing range) is not wide in some cameras. In a case in which the image capturing range is narrow, it is difficult to directly display the reference image in a position corresponding to the position of the power receiving unit 360, unless separated from the charger 3100 by a long distance. On the other hand, if the distance between the smartphone 1 and the charger 3100 is excessively long, it is difficult for the power receiving unit 360 to receive the electromagnetic waves.

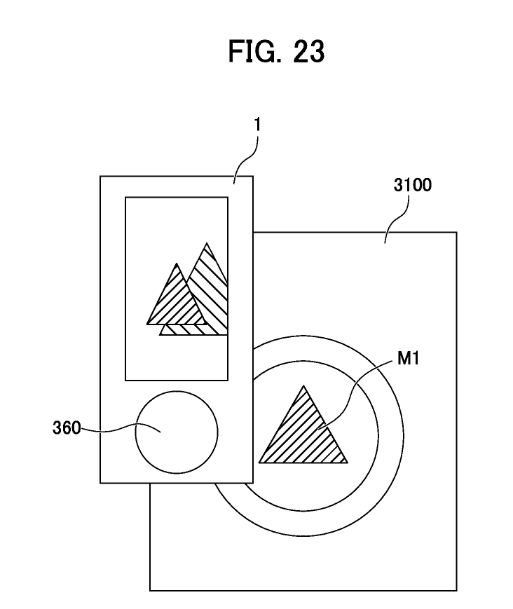

Accordingly, as shown in FIG. 23, a predetermined surface of the charger 3100 is marked with the mark M1 indicating the position of the coil 3101 transmitting electromagnetic waves, and a single circle or a plurality of circles at a certain interval around the mark M1. The controller 10 calculates the relative position, based on the circle(s) captured by the camera 13. In a case of this configuration, the smartphone 1 can calculate the position of the coil 3101 by recognizing the mark M1 or the circle(s). FIG. 23 shows an example in which the plurality of circles are concentrically indicated at a certain interval around the mark M1.

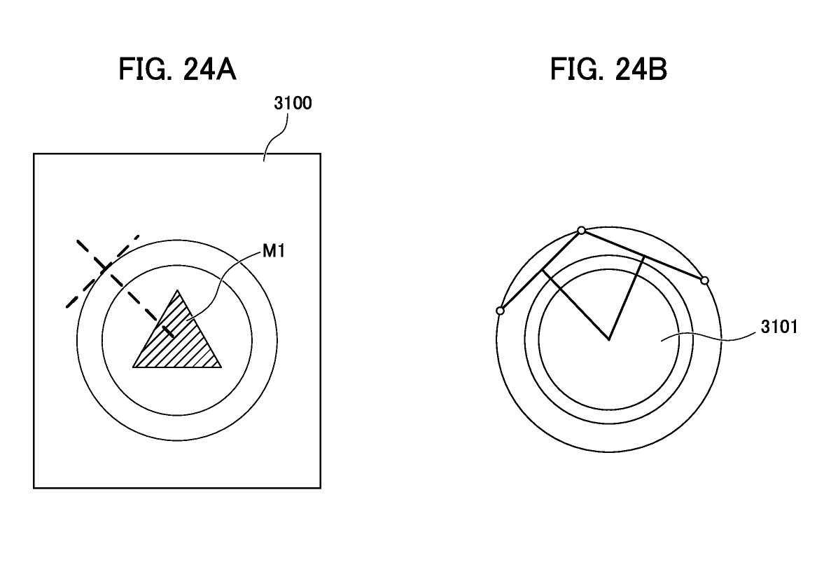

More specifically, as shown in FIG. 24A, the controller 10 analyzes the image captured by the camera 13, and in a case in which a part of the circle is recognized, the controller 10 calculates the position of the built-in coil 3101 of the charger 3100, based on an intersection with the circle. The controller 10 calculates the relative position of the coil 3101 on the basis of the position where the power receiving unit 360 is disposed, and causes the display 2A to display a target image.

As shown in FIG. 24B, the controller 10 captures a circle or an arc by the camera 13, and calculates the center of the circle (circumcenter), based on three points on the captured arc. The center of the circle is the position of the built-in coil 3101 of the charger 3100. The controller 10 calculates the relative position of the coil 3101 on the basis of the position where the power receiving unit 360 is disposed, and causes the display 2A to display a target image.

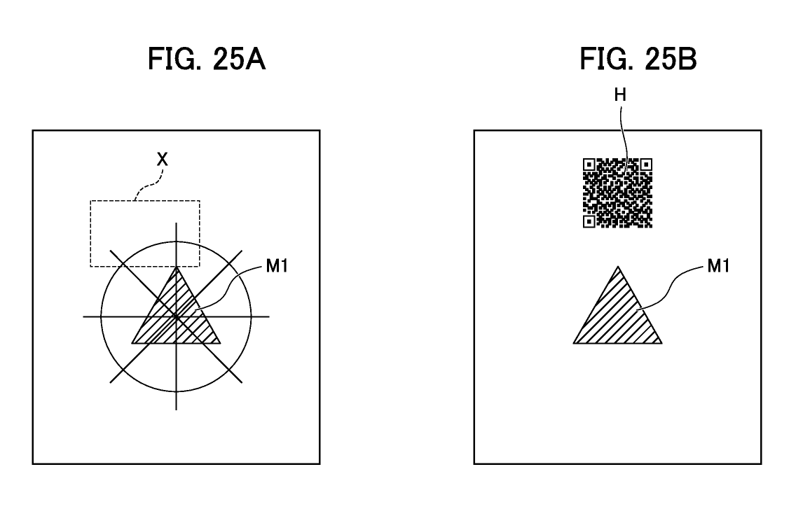

As shown in FIG. 25A, the predetermined surface of the charger 3100 may be configured to be marked with the mark M1 indicating the position of the coil 3101 transmitting electromagnetic waves, the single circle around the mark M1, and a plurality of radially drawn straight lines. For example, the camera 13 captures an area X shown in FIG. 25A. The area X includes an aspect in which two straight lines intersect with parts of the circle. The controller 10 analyzes the image captured by the camera 13, and calculates the position of the built-in coil 3101 of the charger 3100. The controller 10 calculates the relative position of the coil 3101 (the first area R) on the basis of the position where the power receiving unit 360 is disposed, and causes the display 2A to display a target image. In a case of this configuration, the smartphone 1 can calculate the position of the coil 3101 by recognizing the mark M1 or the parts where the two straight lines intersect with the circle.

As shown in FIG. 25B, the predetermined surface of the charger 3100 may be configured to be marked with the mark M1 indicating the position of the coil 3101 transmitting electromagnetic waves, and a two-dimensional code H. The two dimensional code H includes information indicating the position of the built-in coil 3101 of the charger 3100. More specifically, the camera 13 reads the two-dimensional code H. The controller 10 analyzes the two-dimensional code H read by the camera 13, and recognizes the position of the built-in coil 3101 of the charger 3100. The controller 10 calculates the relative position of the coil 3101 on the basis of the position where the power receiving unit 360 is disposed, and causes the display 2A to display a target image. In a case of this configuration, the smartphone 1 can calculate the position of the coil 3101 by recognizing the mark M1 or the two-dimensional code H.

In this manner, even if an image capturing range of a camera is narrow, at a distance where the electromagnetic waves output from the charger 3100 can be received, the guidance system 3200 can guide the smartphone 1 to a position where the efficiency of receiving power from the charger 3100 is high, by displaying a reference image and a target image.

The controller 10 may be configured to measure the perpendicular distance between the smartphone 1 and the charger 3100, and to guide the smartphone 1 to a position where the receiving efficiency is high, in consideration of the height direction as well. In this case, the controller 10 causes the display to display the target image smaller as the smartphone 1 is separated from the mark M1, and to display the target image larger as the smartphone 1 is closer to the mark M1.

The perpendicular distance can be calculated from a captured image by measuring the distance by the camera 13, or by drawing concentric circles with predetermined radii.

The predetermined surface of the charger 3100 may be configured to be marked with a position image indicating the position of the coil 3101 that transmits electromagnetic waves. The controller 10 calculates the relative position of the coil 3101 (the position of the first area R) corresponding to the power receiving unit 360, based on the position image captured by the camera 13.

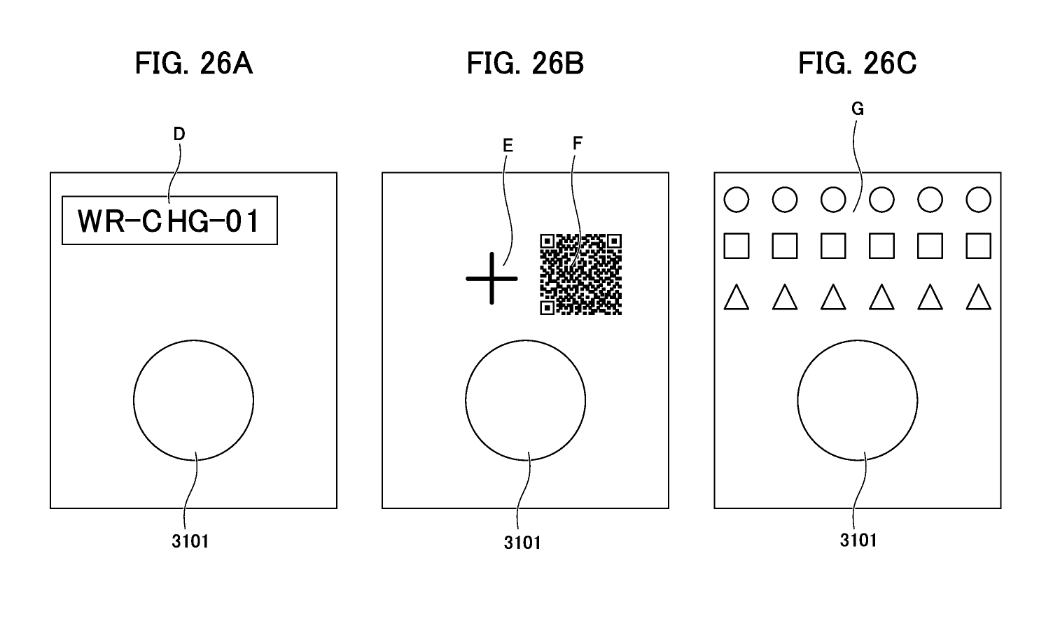

More specifically, as shown in FIG. 26A, character information D is printed as a position image on a predetermined surface of charger 3100. The character information D includes information indicating the position of the built-in coil 3101 of the charger 3100. The character information D may include information of whether the built-in coil 3101 of the charger 3100 can be used, information of the upper limit of power transmission, failure information, interference information, etc. In this case, the smartphone 1 can utilize this information. In the present embodiment, only the character information D is printed, and the coil 3101 is not indicated, on the predetermined surface of charger 3100; however, the present invention is not limited thereto.

The camera 13 reads the character information D. The controller 10 analyzes the character information D read by the camera 13, and recognizes the position of the built-in coil 3101 of the charger 3100. The controller 10 calculates the relative position of the coil 3101 on the basis of the position where the power receiving unit 360 is disposed, and causes the display 2A to display a target image. In a case of this configuration, the smartphone 1 can calculate the position of the coil 3101 (the position of the first area R) by recognizing the character information D.

As shown in FIG. 26B, a recognition mark E and a two-dimensional code F are printed as position images on a predetermined surface of charger 3100. In the present embodiment, the recognition mark E and the two-dimensional code F are printed, and the coil 3101 is not indicated, on the predetermined surface of charger 3100; however, the present invention is not limited thereto.

The camera 13 reads the recognition mark E and the two-dimensional code F. The controller 10 analyzes the recognition mark E and the two-dimensional code F read by the camera 13, and recognizes the position of the built-in coil 3101 of the charger 3100 (the position of the first area R). The controller 10 calculates the relative position of the coil 3101 on the basis of the position where the power receiving unit 360 is disposed, and causes the display 2A to display a target image. In a case of this configuration, the smartphone 1 can calculate the position of the coil 3101 by recognizing the recognition mark E and the two-dimensional code F.

As shown in FIG. 26C, patterns G are printed as a position image on a predetermined surface of charger 3100. In the present embodiment, only the patterns G are printed, and the coil 3101 is not indicated, on the predetermined surface of charger 3100; however, the present invention is not limited thereto. In the present embodiment, a triangular pattern, a quadrangular pattern, and a circular pattern are printed at a predetermined interval in ascending order of distance from the coil 3101. The storage 9 stores a table that defines a positional relationship between the patterns and the coil 3101.

The camera 13 reads the patterns G. The controller 10 analyzes the patterns G read by the camera 13, refers to the table stored in the storage 9, and recognizes a position of the coil 3101. The controller 10 calculates the relative position of the coil 3101 on the basis of the position where the power receiving unit 360 is disposed, and causes the display 2A to display a target image. In a case of this configuration, the smartphone 1 can calculate the position of the coil 3101 by recognizing the patterns G.

The controller 10 is not limited to the configuration described above, and may calculate the position of the coil 3101 (the position of the first area R) by another configuration. For example, a different numeric character may be mixed in the patterns in advance, and the position of the coil 3101 may be calculated based on the type of patterns and the numeric character; or a different symbol may be mixed in the patterns in advance, and the position of the coil 3101 may be calculated based on the an amount of displacement from the symbol as a reference point (for example, the number of circles incrementally displayed from the right to the left).

In this manner, based on the position of the coil 3101 shown as the position image indicating the position of the coil 3101 that transmits electromagnetic waves to a predetermined surface of the charger 3100, the guidance system 3200 can calculate the relative position of the coil 3101 on the basis of the position where the power receiving unit 360 is disposed, and can cause the display 2A to display a target image; therefore, the guidance system 3200 can guide the smartphone 1 to a position where the efficiency of receiving power from the charger 3100 is high.

The controller 10 may be configured to calculate the position of the power receiving unit 360 relative to the position of the charger 3100, based on an image of the charger 3100 captured by the camera 13 upon detecting an operation to start charging, and to cause the display 2A to display a reference image and a target image.

The controller 10 may be configured to terminate the displaying of the reference image and the target image on the display 2A, upon detecting an operation to terminate the charging.

The controller 10 may be configured to terminate the displaying of the reference image and the target image on the display 2A, in a case in which the power receiving efficiency of the rechargeable battery 361 charged by the charging unit 362 is at least a predetermined power receiving efficiency.

The controller 10 may be configured to terminate the displaying of the reference image and the target image on the display 2A, in a case in which the smartphone 1 is proximate to the charger 3100 at a distance equal to or shorter than a predetermined distance.

The controller 10 may be configured to cause the display 2A to display the reference image and the target image again, after terminating the displaying of the reference image and the target image on the display 2A, in a case in which the power receiving efficiency of the rechargeable battery 361 charged by the charging unit 362 is reduced to be no more than a predetermined power receiving efficiency.

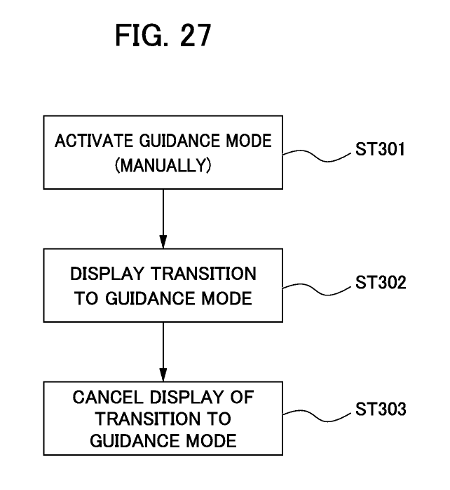

Here, with reference to a flowchart shown in FIG. 27, descriptions are provided for a first method of guiding the smartphone 1 to a position where the efficiency of receiving power from the charger 3100 is high. In the following descriptions, the user attempts to charge the smartphone 1 by bringing the smartphone 1 to be proximate to the charger 3100.

In Step ST301, in a case in which the user's operation to start charging is detected, the controller 10 activates a guidance mode. More specifically, the user executes a predetermined gesture (for example, tap) on an icon for activating the guidance mode for the contactless charge (wireless power feed), the icon being displayed on a home screen. When the gesture on the icon is detected, the controller 10 activates the guidance mode. The guidance mode refers to a mode for guiding the smartphone 1 to a position where the efficiency of receiving power from the charger 3100 is high.

In Step ST302, the controller 10 causes the display to display transition to the guidance mode. More specifically, the controller 10 causes the display 2A to display a reference image and a target image. The user moves the smartphone 1 such that the reference image overlaps with the target image.

In Step ST303, when the controller 10 detects that the user has placed the smartphone 1 to face the charger 3100, the controller 10 cancels the displaying of the transition to the guidance mode. More specifically, the controller 10 terminates the displaying of the target image and the reference image.

In this manner, the guidance system 3200 can guide the smartphone 1 to a position where the efficiency of receiving power from the charger 3100 is high.

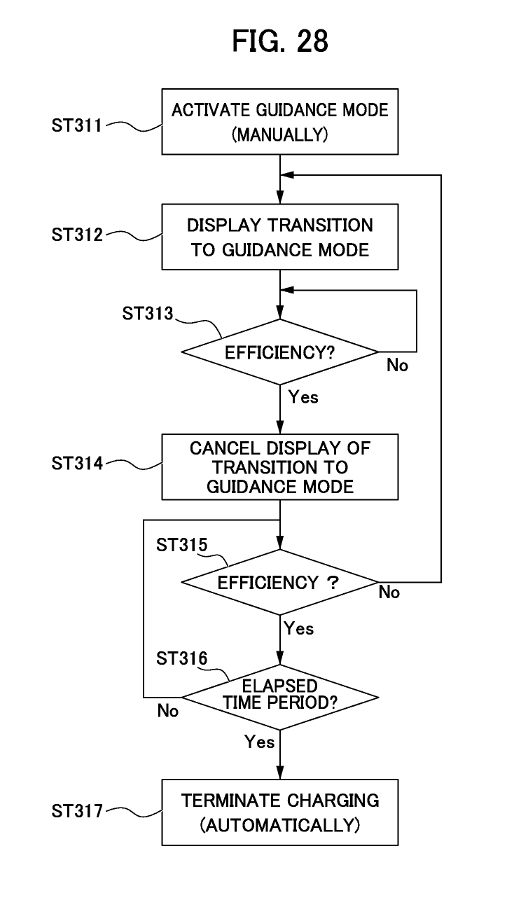

With reference to a flowchart shown in FIG. 28, descriptions are provided for a second method of guiding the smartphone 1 to a position where the efficiency of receiving power from the charger 3100 is high. In the following descriptions, the user attempts to charge the smartphone 1 by bringing the smartphone 1 proximate to the charger 3100.

In Step ST311, in a case in which the user's operation to start charging is detected, the controller 10 activates the guidance mode. More specifically, the user executes a predetermined gesture (for example, tap) on an icon for activating the guidance mode for the contactless charge (wireless power feed), the icon being displayed on a home screen. When the gesture on the icon is detected, the controller 10 activates the guidance mode.

In Step ST312, the controller 10 causes the display to display transition to the guidance mode. More specifically, the controller 10 causes the display 2A to display a reference image and a target image. The user moves the smartphone 1 such that the reference image overlaps with the target image.

In Step ST313, the controller 10 checks the power receiving efficiency of the rechargeable battery 361, and determines whether the power is being received with at least a predetermined power receiving efficiency. In a case of determining that the power is being received with at least a predetermined power receiving efficiency (YES), the processing advances to Step ST314. In a case of determining that the power is not being received with at least a predetermined power receiving efficiency (NO), the processing repeats Step ST313 at a certain interval.

In Step ST314, the controller 10 cancels the displaying of the transition to the guidance mode. More specifically, the controller 10 terminates the displaying of the target image and the reference image. In the present embodiment, it is assumed that the user leaves the smartphone 1 on the charger 3100, in a case in which the displaying of the target image and the reference image is terminated.

In Step ST315, the controller 10 checks the power receiving efficiency of the rechargeable battery 361 at predetermined timing, and determines whether the power is being received with at least a predetermined power receiving efficiency. In a case of determining that the power is being received with at least a predetermined power receiving efficiency (YES), the processing advances to Step ST316. In a case of determining that the power is not being received with at least a predetermined power receiving efficiency (NO), the processing returns to Step ST312.

This assumes a case in which the smartphone 1 is displaced from a position of a higher power receiving efficiency to a position of a lower power receiving efficiency due to some kind of factor (for example, a factor such as unintentionally touching the smartphone 1) after placing the smartphone 1 on the charger 3100. Therefore, in a case in which the smartphone 1 is displaced from a position of a higher power receiving efficiency to a position of a lower power receiving efficiency, i.e. in a case of determining that the power is not being received with at least a predetermined power receiving efficiency, the processing returns to Step ST312, and the transition to the guidance mode is displayed again.

In Step ST316, the controller 10 determines whether a predetermined period of time has elapsed. In a case of determining that the predetermined period of time has elapsed (YES), the processing advances to Step ST317. In a case of determining that the predetermined period of time has not elapsed (NO), the processing returns to Step ST315. In the present step, instead of determining whether a predetermined period of time has elapsed, the controller 10 may determine whether a charged level of the rechargeable battery 361 is at least a predetermined level.

In Step ST317, the controller 10 terminates the power receiving.

In this manner, the guidance system 3200 can guide the smartphone 1 to a position where the efficiency of receiving power from the charger 3100 is high, and in a case in which the power receiving efficiency is deteriorated thereafter, the guidance system 3200 can guide the smartphone 1 again to a position where the power receiving efficiency is high.

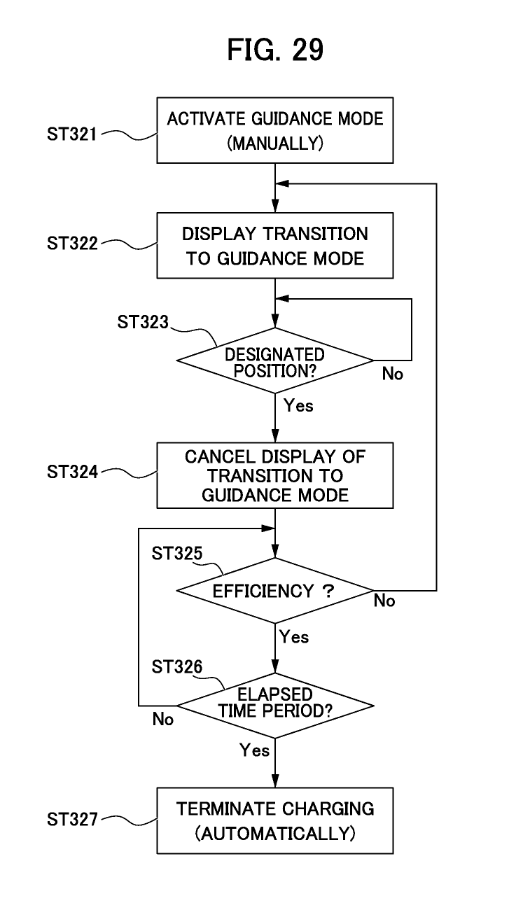

With reference to a flowchart shown in FIG. 29, descriptions are provided for a third method of guiding the smartphone 1 to a position where the efficiency of receiving power from the charger 3100 is high. In the following descriptions, the user attempts to charge the smartphone 1 by making the smartphone 1 proximate to the charger 3100.

In Step ST321, in a case in which the user's operation to start charging is detected, the controller 10 activates the guidance mode. More specifically, the user executes a predetermined gesture (for example, tap) on an icon for activating the guidance mode for the contactless charge (wireless power feed), the icon being displayed on a home screen. When the gesture on the icon is detected, the controller 10 activates the guidance mode.

In Step ST322, the controller 10 causes the display to display transition to the guidance mode. More specifically, the controller 10 causes the display 2A to display a reference image and a target image. The user moves the smartphone 1 such that the reference image overlaps with the target image.

In Step ST323, the controller 10 determines whether the smartphone 1 has been moved to a predetermined designated position. In a case of determining that the smartphone 1 has been moved to the designated position (YES), the processing advances to Step ST324. In a case of determining that the smartphone 1 has not been moved to the designated position (NO), the processing repeats Step ST323. The designated position refers to a position where the power receiving efficiency is high. For example, in a case in which the reference image overlaps with the target image by at least 20%, the controller 10 determines that the smartphone 1 has been moved to the designated position.

In Step ST324, the controller 10 cancels the displaying of the transition to the guidance mode. More specifically, the controller 10 terminates the displaying of the target image and the reference image. In the present embodiment, it is assumed that the user leaves the smartphone 1 on the charger 3100, in a case in which the displaying of the target image and the reference image is terminated.

In Step ST325, the controller 10 checks the power receiving efficiency of the rechargeable battery 361 at predetermined timing, and determines whether the power is being received with at least a predetermined power receiving efficiency. In a case of determining that the power is being received with at least a predetermined power receiving efficiency (YES), the processing advances to Step ST326. In a case of determining that the power is not being received with at least a predetermined power receiving efficiency (NO), the processing returns to Step ST322.

This assumes a case in which the smartphone 1 is displaced from a position of a higher power receiving efficiency to a position of a lower power receiving efficiency due to some kind of factor (for example, a factor such as unintentionally touching the smartphone 1) after placing the smartphone 1 on the charger 3100. Therefore, in a case in which the smartphone 1 is displaced from a position of a higher power receiving efficiency to a position of a lower power receiving efficiency, i.e. in a case of determining that the power is not being received with at least a predetermined power receiving efficiency, the processing returns to Step ST322, and the transition to the guidance mode is displayed again.

In Step ST326, the controller 10 determines whether a predetermined period of time has elapsed. In a case of determining that the predetermined period of time has elapsed (YES), the processing advances to Step ST327. In a case of determining that the predetermined period of time has not elapsed (NO), the processing returns to Step ST325. In the present step, instead of determining whether a predetermined period of time has elapsed, the controller 10 may determine whether a charged level of the rechargeable battery 361 is at least a predetermined level.

In Step ST327, the controller 10 terminates the power receiving.

In this manner, the guidance system 3200 can guide the smartphone 1 to a position where the efficiency of receiving power from the charger 3100 is high, and in a case in which the power receiving efficiency is deteriorated thereafter, the guidance system 3200 can guide the smartphone 1 again to a position where the power receiving efficiency is high.

The controller 10 may be configured to measure a distance between the smartphone 1 and the charger 3100, and to guide the smartphone 1 to a position where the receiving efficiency is high, in consideration of the horizontal direction and the perpendicular direction. More specifically, the controller 10 detects a predetermined distance by a contrast detection method or a phase difference detection method, based on an image captured by the camera 13

The controller 10 causes the display to display the target image smaller as the distance between the smartphone 1 and the charger 3100 is increased, and to display the target image larger as the distance between the smartphone 1 and the charger 3100 is decreased.

In this manner, the guidance system 3200 can three-dimensionally guide the smartphone 1 to a position where the efficiency of receiving power from the charger 3100 is high.

The controller 10 causes the communication unit 6 to acquire placement information of the charger 3100, and in a case in which the smartphone 1 is proximate to the charger 3100 at a distance equal to or shorter than a predetermined distance based on the placement information, the controller 10 causes the camera 13 to capture an image of the charger 3100. The controller 10 may be configured to calculate the position of the power receiving unit 360 relative to the position of the first area R of the charger 3100 based on a captured image, and to cause the display 2A to display a reference image and a target image.

More specifically, the controller 10 causes the communication unit 6 to acquire the placement information of the charger 3100 from a predetermined server. The placement information thus acquired includes information of a position(s) where a single or plurality of the charger 3100 is disposed (for example, latitude and longitude).

The controller 10 refers to GPS information acquired from a GPS acquisition unit (not shown), and in a case in which the smartphone 1 is proximate to the charger 3100 at a distance equal to or shorter than a predetermined distance based on the placement information, the controller 10 causes the camera 13 to capture an image of the charger 3100.

The controller 10 calculates the position of the power receiving unit 360 relative to the position of the charger 3100 based on a captured image, and causes the display 2A to display a reference image and a target image.

In this manner, the guidance system 3200 transitions to the guidance mode in a case in which the smartphone 1 is proximate to the charger 3100 at a distance equal to or shorter than a predetermined distance based on the placement information; therefore, the guidance system 3200 can guide the smartphone 1 to a position where the efficiency of receiving power from the charger 3100 is high, while reducing the operational burden on the user.

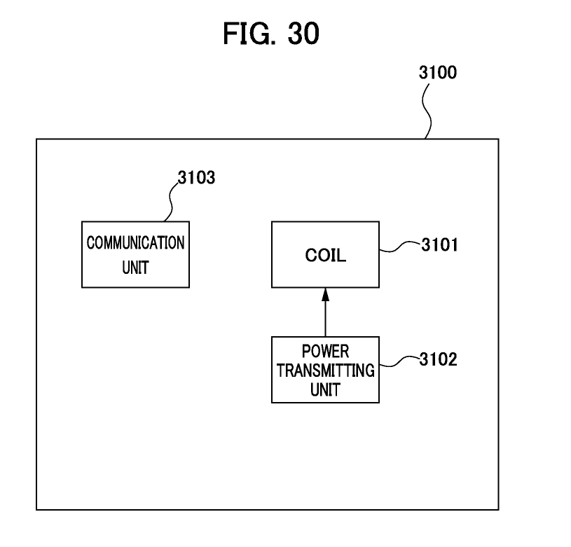

As shown in FIG. 30, the charger 3100 includes a communication unit 103 that consecutively or intermittently supplies a signal. The communication unit 103 performs communication in conformity with a predetermined wireless communication standard. The predetermined wireless communication standard is, for example, WiMAX (registered trademark), IEEE 802.11, Bluetooth (registered trademark), IrDA, NFC, etc.

The charger 3100 includes: a power transmitting unit 102 that transmits power based on power supplied from the power supply; and a coil 3101 that converts the power transmitted from the power transmitting unit 102 into electromagnetic waves to be externally output.

The controller 10 causes the communication unit 6 to detect a signal being output from the communication unit 103, and in a case in which the smartphone 1 is proximate to the charger 3100 at a distance equal to or shorter than a predetermined distance, the controller 10 causes the camera 13 to capture an image of the charger 3100. The controller 10 calculates the position of the power receiving unit 360 relative to the position of the charger 3100 based on a captured image, and causes the display 2A to display a reference image and a target image.

For example, the smartphone 1 consecutively or intermittently operates the communication unit 6, and in a case in which the charger 3100 enters a communication range, the smartphone 1 automatically transitions to the guidance mode.

In this manner, the guidance system 3200 causes the smartphone 1 and the charger 3100 to communicate with each other, and transitions to the guidance mode in a case in which the smartphone 1 is proximate to the charger 3100 at a distance equal to or shorter than a predetermined distance; therefore, the guidance system 3200 can guide the smartphone 1 to a position where the efficiency of receiving power from the charger 3100 is high, while reducing the operational burden on the user.

The controller 10 may be configured to cause the display 2A to display a message for prompting the user to charge the smartphone 1, in a case in which the remaining level of the rechargeable battery 361 is no more than a predetermined value, and the smartphone 1 is proximate to the charger 3100 at a distance equal to or shorter than a predetermined distance.

In this manner, in a case in which the smartphone 1 is proximate to the charger 3100 at a distance equal to or shorter than a predetermined distance when the charging is required; therefore, the guidance system 3200 can avoid running out of battery.

A part or all of the programs stored in the storage 9 as described in FIG. 16 may be downloaded from other devices through wireless communication by the communication unit 6. A part or all of the programs stored in the storage 9 as described in FIG. 16 may be stored in a storage medium that is readable by a reader included in the storage 9. A part or all of the programs stored in the storage 9 as described in FIG. 16 may be stored in a storage medium such as a CD, a DVD or a Blu-ray that is readable by a reader connected to the external interface 14.

The configuration of the smartphone 1 shown in FIG. 16 is an example, and may be altered as appropriate within the scope without departing from the spirit of the present invention. For example, the number and type of the button(s) 3 are not limited to the example shown in FIG. 16. For example, the smartphone 1 may include buttons with a numeric keypad layout or a QWERTY keyboard layout, in place of the buttons 3A to 3C, as buttons for operations regarding screens. The smartphone 1 may include only a single button and need not include any button, for operations regarding screens. In the example shown in FIG. 16, the smartphone 1 includes two cameras, but the smartphone 1 may include only a single camera, and need not include any camera. In the example shown in FIG. 16, the smartphone 1 includes three types of sensors for detecting the position and posture, but the smartphone 1 need not include some of these sensors, and may include other types of sensors for detecting the position and posture. The illuminance sensor 4 and the proximity sensor 5 may be configured as a single sensor instead of separate sensors.

Characteristic embodiments have been described for the purpose of completely and clearly disclosing the present invention. However, the present invention is not to be limited to the above embodiment, and the invention is to be configured to embody all modifications and substitutable configurations that can be created by a person skilled in the art within the scope of the basic matter described herein.

For example, each program shown in FIG. 16 may be divided into a plurality of modules, and may be coupled with other programs.

In the above embodiments, the smartphone has been described as an example of a device including a touch-screen display, but the device of the present invention is not limited to a smartphone. For example, the device of the present invention may be a portable electronic device such as a mobile phone, a portable personal computer, a digital camera, a media player, an electronic book reader, a navigator or a gaming machine. The device of the present invention may be a non-portable electronic device, such as a desktop PC or a television set.

What is claimed is:

1. A system comprising:
a charger that includes a plurality of power transmitting units that transmit power through electromagnetic waves; and
an electronic device including a power receiving unit for receiving power transmitted from the power transmitting units, a communication unit for communicating with a base station, and a storage unit for storing information of communication quality of the communication unit with the base station when the power receiving unit is receiving power,
wherein the electronic device selects, from among the plurality of power transmitting units, a combination of the power transmitting units for transmitting power, based on the information of the communication quality stored in the storage unit, and
wherein the charger transmits power by the power transmitting units, based on the selection by the electronic device.

2. The system according to claim 1,
wherein the electronic device selects a combination of the power transmitting units with which the communication quality is of at least a predetermined standard.

3. The system according to claim 2,
wherein, in a case in which there are a plurality of combinations of the power transmitting units with which the communication quality is of at least the predetermined standard, the electronic device selects a combination with which the communication quality is the best.

4. The system according to claim 2,
wherein, in a case in which there is no combination of the power transmitting units with which the communication quality is of at least the predetermined standard, the electronic device selects a combination with which the communication quality is the best, among the combinations with which the communication quality is below the predetermined standard.

5. The system according to claim 2,
wherein the electronic device includes a notification unit for notifying that the communication quality is deteriorated, in a case in which there is no combination of the power transmitting units with which the communication quality is of at least the predetermined standard.

6. The system according to claim 4,
wherein, in a case in which there is no combination of the power transmitting units with which the communication quality is of at least the predetermined standard, the electronic device instructs the charger to reduce an amount of transmitting power from the power transmitting units.

7. A system comprising:
a charger that includes a plurality of power transmitting units that transmit power through electromagnetic waves; and
an electronic device including a power receiving unit for receiving power transmitted from the power transmitting units, a communication unit for communicating with a base station, and a storage unit for storing information of communication quality of the communication unit with the base station when the power receiving unit is receiving power,
wherein the electronic device selects, from among the plurality of power transmitting units, a combination of the power transmitting units for transmitting power, based on charging efficiency of power in the power receiving unit, and based on the information of the communication quality stored in the storage unit, and
wherein the charger transmits power by the power transmitting units, based on the selection by the electronic device.

8. The system according to claim 7,
wherein the electronic device selects a combination of the power transmitting units with which the charging efficiency is at least a predetermined efficiency and the communication quality is of at least a predetermined standard.

9. The system according to claim 8,
wherein, in a case in which there are a plurality of combinations of the power transmitting units with which the charging efficiency is at least the predetermined efficiency and the communication quality is of at least the predetermined standard, the electronic device selects a combination with which the communication quality is the best among the combinations.

10. The system according to claim 8,
wherein, in a case in which there are a plurality of combinations of the power transmitting units with which the charging efficiency is at least the predetermined efficiency and the communication quality is of at least the predetermined standard, the electronic device selects a combination with which the charging efficiency is the best among the combinations.

11. The system according to claim 7,
wherein, in a case in which there is no combination of the power transmitting units with which the charging efficiency is at least the predetermined efficiency and the communication quality is of at least the predetermined standard, the electronic device selects a combination with which the communication quality is the best, among the combinations with which the communication quality is below the predetermined standard.

12. The system according to claim 7,
wherein the electronic device includes a notification unit for notifying that the communication quality is deteriorated, in a case in which there is no combination of the power transmitting units with which the charging efficiency is at least the predetermined efficiency and the communication quality is of at least the predetermined standard.

13. A system comprising:
a charger that includes a plurality of power transmitting units that transmit power through electromagnetic waves; and
an electronic device including a power receiving unit for receiving power transmitted from the power transmitting units, a communication unit for communicating with a base station, and a storage unit for storing information of communication quality of the communication unit with the base station when the power receiving unit is receiving power;
wherein the electronic device transmits the information of the communication quality stored in the storage unit to the charger, and
wherein the charger transmits power by the power transmitting units, based on the information from the electronic device.

14. A system comprising:
a charger that includes a plurality of power transmitting units that transmit power through electromagnetic waves; and
an electronic device including a power receiving unit for receiving power transmitted from the power transmitting units, a communication unit for communicating with a base station, and a storage unit for storing information of communication quality of the communication unit with the base station when the power receiving unit is receiving power,
wherein the electronic device transmits power charging efficiency in the power receiving unit, and information of the communication quality stored in the storage unit, to the charger, and
wherein the charger transmits power by the power transmitting units, based on the information from the electronic device.

15. An electronic device, comprising:
a power receiving unit that receives power transmitted through electromagnetic waves from a charger including a plurality of power transmitting units;
a communication unit that communicates with a base station;
a storage unit that stores information of communication quality of the communication unit with the base station when the power receiving unit is receiving power;
a control unit that selects, from among the plurality of power transmitting units, a combination of the power transmitting units for transmitting power, based on the information of the communication quality stored in the storage unit; and
a transmitting unit that transmits the combination selected by the control unit to a charger.

16. An electronic device, comprising:
a power receiving unit that receives power transmitted through electromagnetic waves from a charger including a plurality of power transmitting units;
a communication unit that communicates with a base station;
a storage unit that stores information of communication quality of the communication unit with the base station when the power receiving unit is receiving power;
a control unit that selects, from among the plurality of power transmitting units, a combination of the power transmitting units for transmitting power, based on charging efficiency of power in the power receiving unit, and based on the information of the communication quality stored in the storage unit; and
a transmitting unit that transmits the combination selected by the control unit to a charger.

17. A system comprising:
an electronic device; and
a charger;
wherein the electronic device includes:
an antenna unit that transmits or receives first electromagnetic waves that are used for communication;
a plurality of power receiving units that receive power through second electromagnetic waves that are used for charging; and
a first control unit that controls a second power receiving unit to receive power through the second electromagnetic waves in a case in which the antenna unit transmits or receives the first electromagnetic waves, the second power receiving unit being different from the first power receiving unit that is closest to the antenna unit among the plurality of power receiving units, and
wherein the charger includes:
a power transmitting unit that transmits power through the second electromagnetic waves to a part or all of the plurality of power receiving units; and
a second control unit that controls the power transmitting unit to transmit power through the second electromagnetic waves to the second power receiving unit in a case in which the antenna unit transmits or receives the first electromagnetic waves.

18. The system according to claim 17,
wherein the first control unit includes a communication priority mode in which the antenna unit transmits or receives data, and
wherein, in the communication priority mode, the first control unit uses the second power receiving unit to receive power through the second electromagnetic waves, instead of using the first power receiving unit.

19. The system according to claim 18,
wherein, in a case in which power is received through the second electromagnetic waves, and received signal strength of the first electromagnetic waves received by the antenna unit is below a preset second threshold value, the first control unit sets the communication priority mode.

20. The system according to claim 17,
wherein the first control unit includes a power receiving priority mode for prioritizing power receiving, and
wherein, in the power receiving priority mode, at least two of the power receiving units are used to receive power.

21. The system according to claim 20,
wherein the electronic device further includes a secondary battery that stores power received by at least one of the plurality of power receiving units, and
wherein, in a case in which a remaining battery level of the secondary battery is below a preset first threshold value, the first control unit sets the power receiving priority mode.

22. The system according to claim 17,
wherein one of the plurality of power receiving units is a contactless antenna unit utilized for contactless communication.

23. The system according to claim 17,
wherein the electronic device includes a transmitting unit that transmits a control signal for controlling power to be transmitted through the second electromagnetic waves toward the second power receiving unit in the communication priority mode,
wherein the charger further includes a receiving unit that receives the control signal, and
wherein the second control unit controls the power transmitting unit, based on the control signal.

24. The system as claimed in claim 23,
wherein the power transmitting unit receives the control signal.

25. The system as claimed in claim 24,
wherein the power transmitting unit receives the control signal through third electromagnetic waves different in frequency from the second electromagnetic waves.

26. An electronic device, comprising:
an antenna unit that transmits or receives first electromagnetic waves that are used for communication;
a plurality of power receiving units that receive power through second electromagnetic waves that are used for charging; and
a control unit that controls a second power receiving unit to receive power through the second electromagnetic waves in a case in which the antenna unit transmits or receives the first electromagnetic waves, the second power receiving unit being different from the first power receiving unit that is closest to the antenna unit among the plurality of power receiving units.

27. A system comprising:
a charger that includes a predetermined surface having a first area, and transmits power through electromagnetic waves; and
an electronic device that receives power from the charger, and receives power with at least a predetermined efficiency when the electronic device is disposed in the first area,
wherein the electronic device includes:
an image capturing unit;
a control unit that calculates its relative position with respect to the first area, based on an image of the charger captured by the image capturing unit; and
a notification unit that notifies information regarding the relative position calculated by the control unit.

28. The system according to claim 27,
wherein the notification unit is a display unit, and
wherein the control unit causes the display unit to display a reference image that is based on a position where a power receiving unit for receiving power through electromagnetic waves from the charger is disposed, and a target image that is based on the relative position thus calculated.

29. The system according to claim 28,
wherein the control unit causes the display unit to display the target image that is identical in shape with the reference image.

30. The system according to claim 27,
wherein the charger is marked with a mark indicating a coil position, the coil being for transmitting electromagnetic waves, and
wherein the control unit calculates the relative position, based on the mark captured by the image capturing unit.

31. The system according to claim 27,
wherein the charger is marked with a mark indicating a coil position, the coil being for transmitting electromagnetic waves, and a single or a plurality of circles at a certain interval around the mark, and
wherein the control unit calculates the relative position, based on the circle(s) captured by the image capturing unit.

32. The system according to claim 27,
wherein the charger is marked with a position image indicating a coil position, the coil being for transmitting electromagnetic waves, and
wherein the control unit calculates the relative position, based on the position image captured by the image capturing unit.

33. The system according to claim 28,
wherein, in a case of detecting an operation to start charging, the control unit calculates the relative position based on the image of the charger captured by the image capturing unit, and causes the display unit to display the reference image and the target image.

34. The system according to claim 28,
wherein the control unit terminates the displaying of the reference image and the target image on the display unit, in a case in which the electronic device is placed on the charger.

35. The system according to claim 28,
wherein the control unit terminates the displaying of the reference image and the target image on the display unit, in a case in which a charging unit charges a rechargeable battery with at least a predetermined power receiving efficiency.

36. The system according to claim 28,
wherein the control unit terminates the displaying of the reference image and the target image on the display unit, in a case in which the electronic device is proximate to the charger at a distance equal to or shorter than a predetermined distance.

37. The system according to claim 36,
wherein the control unit detects the predetermined distance by a contrast detection method or a phase difference detection method which is based on the image captured by the image capturing unit.

38. The system according to claim 34,
wherein the control unit causes the display unit to display the reference image and the target image again, after terminating the displaying of the reference image and the target image on the display unit, in a case in which power receiving efficiency for a rechargeable battery charged by a charging unit is reduced to be no more than the power receiving efficiency.

39. The system according to claim 28,
wherein the control unit acquires placement information of the charger, and in a case in which the electronic device is proximate to the charger at a distance equal to or shorter than a predetermined distance based on the placement information, the control unit causes the image capturing unit to capture an image of the charger, calculates the relative position based on the image, and causes the display unit to display the reference image and the target image.

40. The system according to claim 28,
wherein the charger includes a communication unit that outputs a signal, and
wherein, in a case in which the electronic device is proximate to the charger at a distance equal to or shorter than a predetermined distance as a result of detecting the signal that is output from the communication unit, the control unit causes the image capturing unit to capture an image of the charger, calculates the relative position based on the image, and causes the display unit to display the reference image and the target image.

41. The system according to claim 39,
wherein the control unit causes the display unit to display a message for prompting a user to start charging, in a case in which remaining level of a rechargeable battery is no more than a predetermined value, and the electronic device is proximate to the charger at a distance equal to or shorter than a predetermined distance.

42. An electronic device that receives power from a charger, the electronic device comprising:
an image capturing unit;
a control unit that calculates its relative position with respect to a first area, based on an image of the charger captured by the image capturing unit; and
a notification unit that notifies information regarding the relative position calculated by the control unit.

43. A charger that includes a predetermined surface having a first area, and transmits power through electromagnetic waves to the electronic device with at least a predetermined efficiency, in a case in which an electronic device including an image capturing unit is placed in the first area,
wherein the charger is marked with a mark or a position image to be captured by the image capturing unit, for the electronic device to calculate relative positions of the first area and the electronic device.
